(19) United States
(12) Patent Application Publication
(10) Pub. No.: US 2022/0292276 A1
(43) Pub. Date: Sep. 15, 2022

(54) SCANNER FOR MULTI-DIMENSIONAL CODE AND LABELS

(71) Applicants: Stratio, Inc., San Jose, CA (US); Stratio, Seoul (KR); Korea Minting and Security Printing Corporation, Daejeon (KR)

(72) Inventors: Jae Hyung LEE, Palo Alto, CA (US); Su Ryeo OH, San Francisco, CA (US); Yeul NA, East Palo Alto, CA (US); Se Jin PARK, San Jose, CA (US); Youngsik KIM, Seoul (KR); Wongyun CHOE, Daejeon (KR); Il-hoon CHOI, Daejeon (KR); Bomjoon SEO, Daejeon (KR); Sunghyun JOO, Sejong (KR); Hwasup SHIN, Sejong (KR); Minsoo CHO, Daejeon (KR)

(21) Appl. No.: 17/825,954

(22) Filed: May 26, 2022

Related U.S. Application Data
(63) Continuation of application No. PCT/US2020/061945, filed on Nov. 24, 2020.
(60) Provisional application No. 62/941,547, filed on Nov. 27, 2019.
(60) Provisional application No. 62/942,611, filed on Dec. 2, 2019.
(60) Provisional application No. 62/972,592, filed on Feb. 10, 2020.

(51) Int. Cl. G06K 7/14; G06K 7/12

(52) U.S. Cl. CPC G06K 7/1426; G06K 7/12

(57) ABSTRACT

A method performed at an electronic device with one or more processors and memory storing one or more programs includes receiving a plurality of images of a machine readable code. A respective image of the plurality of images corresponds to a distinct wavelength. The method also includes analyzing the respective image of the plurality of images to obtain a respective processed information; combining the respective processed information to obtain combined information; and providing the combined information to at least one program of the one or more programs stored in the memory for processing.

### RELATED APPLICATIONS

This application is a continuation application of International Application No. PCT/US2020/061945, filed Nov. 24, 2020, which claims the benefit and priority to U.S. Provisional Application No. 62/941,547, filed Nov. 27, 2019, U.S. Provisional Application No. 62/942,611, filed Dec. 2, 2019, and U.S. Provisional Application No. 62/972,592, filed Feb. 10, 2020, each of which is incorporated by reference in its entirety.

### GOVERNMENTAL SUPPORT

This work was partially supported by Korea Institute for Advancement of Technology (KIAT) grant funded by the Korea government (MOTIE) (No. P0009472, Development of an Artificial Intelligence Security Solution with a Smartphone Compatible Short Wavelength Infra-Red Hyper-Spectral Imaging System & an Infrared Ink), Korea Institute of Planning and Evaluation for Technology in Food, Agriculture, Forestry (IPET) through High Value-added Food Technology Development Program, funded by Ministry of Agriculture, Food and Rural Affairs (MAFRA) (award no. 117062-3), and Institute of Information & Communications Technology Planning & Evaluation (IITP) grant funded by the Korea government (MSIT) (No. 2019-0-01751, Development of a Smartphone Compatible Short Wavelength Infra-Red Smart Camera & a Hyper-Spectral Imaging System for Hazardous Material Detection).

### BACKGROUND

Controlled distribution of regulated products, such as pharmaceuticals and tobacco products, is important in improving the public health.

The World Health Organization (WHO) estimates that 1.1 billion people smoke worldwide. Tobacco kills more than 7 million people each year, accounting for more death than HIV/AIDS, tuberculosis, and malaria combined (World Bank Group. 2019. Confronting Illicit Tobacco Trade). In 2017 over 5.4 trillion cigarettes were sold, worth $699.4 billion in retail values. WHO Framework Convention on Tobacco Control (WHO FCTC) was developed and entered into force in February 2005. There are currently 181 Parties to the Convention.

A number of measures have since been adopted, including graphic pack warnings and bans on tobacco advertising. Although evidence shows that tobacco taxes are the most cost-effective way to reduce tobacco use, illicit trade in tobacco products is undermining tobacco tax policy. It is estimated that 10% of tobacco products consumed globally are illicit (World Health Organization. 2018. “Tobacco.” Last modified Mar. 9, 2018. https://www.who.int/news-room/fact-sheets/detail/tobacco), costing governments $40.5 billion in lost tax revenues every year (World Health Organization Regional Office for the Eastern Mediterranean. n.d. “Illicit trade increases tobacco use.” Last accessed Apr. 22, 2019. http://www.emro.who.int/noncommunicable-diseases/highlights/illicit-trade-increases-tobacco-use.html).

Against such backdrop, World Health Organization (WHO) adopted a treaty that entered into force in September 2018. The treaty requires that unique, secure, and counterfeit-resistant identification markings be affixed to or form part of all unit packets and packages of cigarettes within 5 years. However, current technologies do not fully meet the qualifications of information carrying capacity, counterfeit-resistance, and price accessibility required by the law and from the industry. Therefore, there is a need for methods and devices that would reduce or eliminate uncontrolled distribution of regulated products.

Furthermore, it is estimated that 98% of illicit cigarettes traded globally are products of legitimate tobacco manufacturers (The Tobacco Atlas. n.d. “Illicit Trade.” Last accessed Apr. 24, 2019. https://tobaccoatlas.org/topic/illicit-trade), giving rise to the need for international governmental collaboration to develop scientific and institutional capacity to implement. Therefore, Protocol to Eliminate Illicit Trade in Tobacco Products (Seoul Protocol), the first Protocol to the WHO FCTC, entered into force in September 2018. There are 51 Parties as of Apr. 24, 2019.

The Seoul Protocol requires unique, secure, and counterfeit-resistant identification markings to be affixed to or form part of all unit packets and packages and any outside packaging of cigarettes within 5 years and other tobacco products within of 10 years of entry into force of the Protocol for that Party (United Nations Treaty Collection. n.d. “Protocol to Eliminate Illicit Trade in Tobacco Products.” Last accessed Apr. 24, 2019. https://treaties.un.org/doc/Treaties/2012/12/20121206%2005-00%20PM/ix-4-a.pdf). Various types of anti-counterfeiting technologies and devices are currently in the market, including special inks, embossing, holograms, RFID, digital watermarking, and different codes (e.g., one-dimensional barcodes and two-dimensional barcodes).

However, there is a tradeoff between affordability and counterfeit-resistance, which has been a major hindrance to widespread adoption. In order to meet the functional requirements of the Seoul Protocol and at the same time price target of the tobacco industry, there is a need for anti-counterfeit packaging technologies that will provide information abundance, counterfeit-resistance, and price accessibility.

### SUMMARY

The code, labels, devices, and methods described herein address such challenges in conventional methods and devices. The disclosed devices can read unique three-dimensional code (e.g., three-dimensional (3D) matrix barcode), and can be made available at a price much lower than the existing 3D scanner technologies.

In accordance with some embodiments, a method is performed at an electronic device with one or more processors and memory storing one or more programs. The method includes receiving a plurality of images of a machine readable code, a respective image of the plurality of images corresponding to a distinct wavelength; analyzing the respective image of the plurality of images to obtain a respective processed information; combining the respective processed information to obtain combined information; and providing the combined information to at least one program of the one or more programs stored in the memory for processing.

In accordance with some embodiments, an electronic device includes one or more processors; and memory storing one or more programs. The one or more programs include instructions, which, when executed by the one or more processors, cause the electronic device to: receive a plurality of images of a machine readable code, a respective image of the plurality of images corresponding to a distinct wavelength; analyze the respective image of the plurality of images to obtain a respective processed information; combine the respective processed information to obtain combined information; and provide the combined information to at least one program of the one or more programs stored in the memory for processing.

In accordance with some embodiments, a computer readable storage medium stores one or more programs for execution by one or more processors of an electronic device. The one or more programs include instructions for: receiving a plurality of images of a machine readable code, a respective image of the plurality of images corresponding to a distinct wavelength; analyzing the respective image of the plurality of images to obtain a respective processed information; combining the respective processed information to obtain combined information; and providing the combined information to at least one program of the one or more programs stored in memory of the electronic device for processing.

In accordance with some embodiments, a method is performed at an electronic device with one or more processors and memory. The method includes receiving a plurality of images of a machine readable code, a respective image of the plurality of images corresponding to a distinct wavelength; analyzing the respective image of the plurality of images to obtain a respective processed information; combining the respective processed information to obtain combined information; determining that the combined information satisfies authenticity criteria; and providing for display information indicating that the machine readable code is authentic.

### BRIEF DESCRIPTION OF THE DRAWINGS

For a better understanding of the aforementioned aspects as well as additional aspects and embodiments thereof, reference should be made to the Description of Embodiments below, in conjunction with the following drawings.

FIG. 1A is a schematic diagram of a 3D-matrix barcode printed on a cigarette pack in accordance with some embodiments.

FIG. 1B illustrates example 3D-matrix barcode patterns detected in visible range (450-750 nm) and the images read by 3D-label scanner in infrared ranges (800-1600 nm).

FIG. 1C is a block diagram illustrating a software system for a 3D-label scanner in accordance with some embodiments.

FIG. 1D is a block diagram illustrating an information reconstruction sub-system in accordance with some embodiments.

FIG. 1E illustrates operations of a smartphone compatible software system for 3D-label scanner in accordance with some embodiments.

FIG. 2A is a partial cross-sectional view of a semiconductor optical sensor device in accordance with some embodiments.

FIG. 2B is a partial cross-sectional view of the semiconductor optical sensor device illustrated in FIG. 2A, in accordance with some embodiments.

FIG. 3A is a schematic diagram illustrating an operation of a semiconductor optical sensor device in accordance with some embodiments.

FIG. 3B is a schematic diagram illustrating the operation of the semiconductor optical sensor device illustrated in FIG. 3A, in accordance with some embodiments.

FIG. 4A is a schematic diagram illustrating a single channel configuration of a semiconductor optical sensor device in accordance with some embodiments.

FIG. 4B is a schematic diagram illustrating a multi-channel configuration of a semiconductor optical sensor device in accordance with some embodiments.

FIG. 5 is a partial cross-sectional view of semiconductor optical sensor devices in accordance with some embodiments.

FIG. 6 illustrates an exemplary sensor circuit in accordance with some embodiments.

FIG. 7A illustrates an exemplary 3T-APS circuit in accordance with some embodiments.

FIG. 7B illustrates an exemplary 1T-MAPS circuit in accordance with some embodiments.

FIGS. 8A-8H illustrate exemplary sensor circuits in accordance with some embodiments.

FIGS. 9A-9C illustrate exemplary converter circuits in accordance with some embodiments.

FIG. 10 illustrates an exemplary image sensor device in accordance with some embodiments.

FIGS. 11A-11E illustrate an exemplary method for making a semiconductor optical sensor device in accordance with some embodiments.

FIG. 12 illustrates spectrometers in accordance with some embodiments.

FIG. 13 illustrates a spectrometer in accordance with some embodiments.

FIGS. 14A-14C illustrate a prism assembly and its components in accordance with some embodiments.

FIGS. 15A-15C illustrate a prism assembly and its components in accordance with some embodiments.

FIGS. 16A-16B illustrate a prism assembly and its components in accordance with some embodiments.

FIGS. 17A-17B illustrate a prism assembly and its components in accordance with some embodiments.

FIGS. 18A-18B illustrate a prism assembly and its components in accordance with some embodiments.

FIG. 19 illustrate rays passing through a prism assembly shown in FIGS. 16A-16B.

FIG. 20 illustrate rays in a spectrometer with the prism assembly shown in FIGS. 16A-16B in accordance with some embodiments.

FIG. 21 is a block diagram illustrating electronic components of an optical device in accordance with some embodiments.

FIG. 22 is a flow chart representing a method of processing images of a machine readable barcode in accordance with some embodiments.

FIG. 23 is a schematic diagram illustrating a plurality of images of a machine readable barcode taken at different wavelengths in accordance with some embodiments.

Like reference numerals refer to corresponding parts throughout the figures.

Unless noted otherwise, the figures are not drawn to scale.

### DETAILED DESCRIPTION

The challenges are addressed by a combination of 3D-matrix barcode and a 3D-label scanner disclosed herein. The disclosed 3D-matrix barcode includes a set of printed patterns containing some information hidden (e.g., invisible) to the naked eyes or conventional visible camera. The disclosed 3D-label scanner includes an optical scanner that can read out the hidden information from 3D-matrix barcodes. Because 3D-matrix barcode hides the information through the selection of various special infrared inks, the hidden information (e.g., the invisible information) can be read only by 3D-label scanner, which is configured to read the 3D-matrix barcode at specific infrared wavelengths.

There are several characteristics of infrared inks that can be used to make 3D-matrix barcode. Some inks absorb infrared lights at a specific wavelength range, while other inks reflect infrared lights at another specific wavelength range. Another type of inks has fluorescence in a specific infrared wavelength range after absorbing ultraviolet or visible lights.

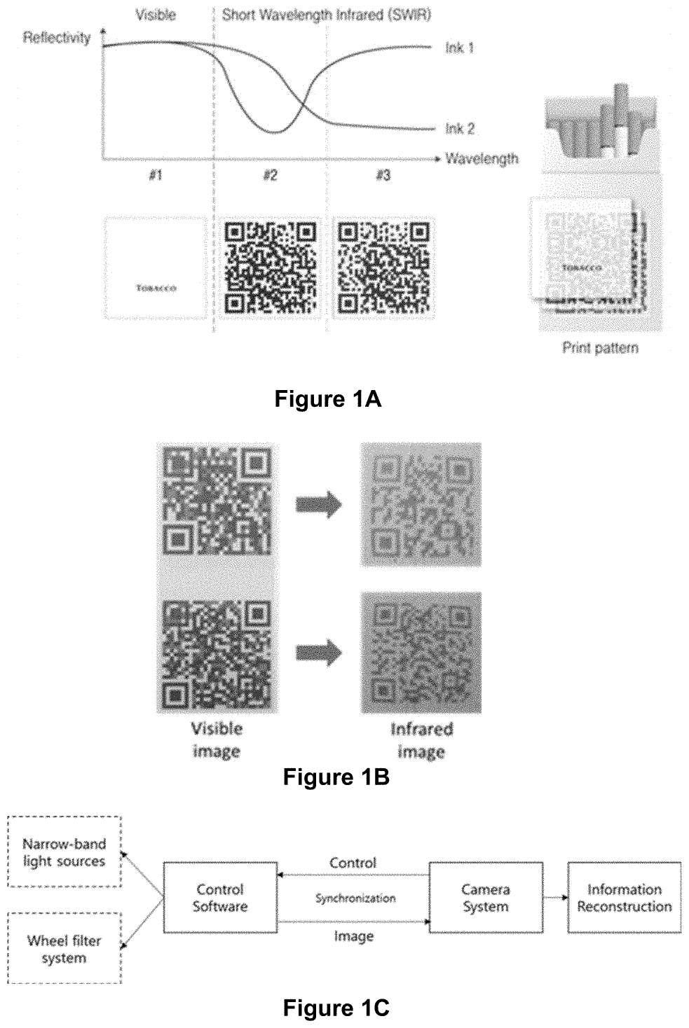

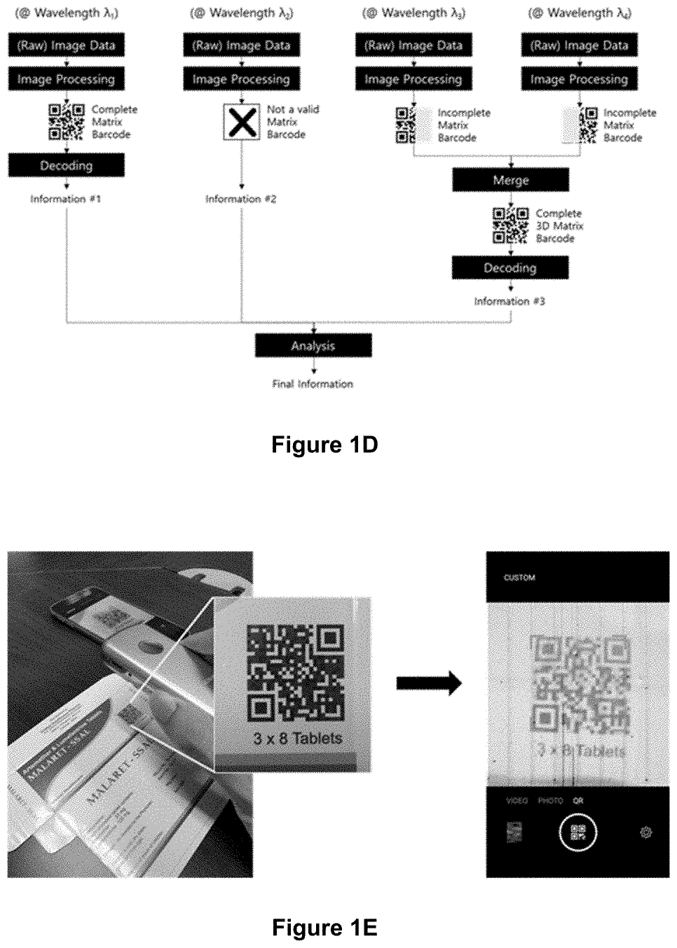

Once a set of inks are selected, there can be two printing methods. First, the 3D-matrix barcode may be printed one matrix barcode pattern layer at a time using one of the inks to create a layered pattern. This layered pattern may be seen as a completely meaningless pattern to the naked eyes, or no pattern may be seen at all to the naked eyes. However, by looking at this layered pattern at a specific infrared wavelength, the disclosed devices may read a meaningful matrix barcode printed by the corresponding infrared ink. Each pattern layer may have a complete matrix barcode to increase the amount of information, or one matrix barcode can be separated into layers so that no one can obtain any information without knowing which wavelengths to look at (FIG. 1A).

Second, we can mix up a set of various inks to create “one ink” with a complicated spectral responses in the visible/infrared region (for example, 400-1600 nm). The 3D-matrix barcode can be more secure than the 2D-matrix barcode as the 3D-matrix barcode includes the spectral responses even though it looks exactly like the 2D-matrix barcode.

Additionally, there can be another top layer which is irrelevant to infrared inks. It helps to hide the existence of a 3D-matrix barcode and further prevents the attempt to analyze and counterfeit the pattern. A well-known pattern, such as an emblem or a logo, can be printed on top of the 3D-matrix barcode using conventional visible inks (e.g., FIG. 1A). Similarly, a film that is transparent in the infrared light but opaque in visible light can be applied on top of the 3D-matrix barcode to achieve the same goal.

The 3D-label scanner is implemented using a short wavelength infrared (SWIR) image sensors that cover from 400-1600 nm wavelength. For example, matrix barcodes that are only visible in the SWIR region could be read by the 3D-label scanner, but not by other conventional CMOS image sensors/cameras.

In some embodiments, the optical system can detect the specific wavelength (e.g., differentiate only a subset of the detectable wavelength range from the rest of the detectable wavelength range) to read the 3D-matrix barcode. In some embodiments, 3D-label scanner could have a number of optical band-pass filters. Each filter allows only a narrow band of visible/infrared lights to be transmitted. By looking at the image of the 3D matrix barcode taken with a band-pass filter, it is possible to read the matrix barcode invisible to the naked eyes (FIG. 1B).

In such embodiments, various band-pass filters are needed to read all printed layers of the 3D-matrix barcode. A motorized wheel filter system or multiple narrow-band illumination sources (for example, several visible or infrared LEDs) can be used to implement the optical system.

FIG. 1C shows the overview block diagram of the software system for a 3D-label scanner. It may contain four major sub-systems:
a. a controller for the optical system, for example, a motorized wheel-filter system or the narrow-band light sources,
b. a camera system software to take images,
c. a synchronization sub-system to take images when the optical system allows only a specific wavelength of light, and
d. an information reconstruction sub-system to retrieve an information from the 3D matrix barcode images taken at various wavelengths of light.

An example block diagram of the information reconstruction sub-system is shown in FIG. 1D. The images taken at a specific wavelength of light may pass through various image processing steps to facilitate the decoding process by enhancing the quality of the images. For example, distortion removal, thresholding, and noise reduction can be applied to the raw image data. Once image processing is done, a processed image may have either a complete matrix barcode, or an incomplete matrix barcode. Sometimes, the processed image may not contain a valid matrix barcode at all. If an image has a complete matrix barcode, the information reconstruction software sub-system decodes the pattern to retrieve information (Information #1 in FIG. 1D). If an image has an incomplete matrix barcode, the software sub-system may merge more than one image to complete a matrix barcode from several partial matrix barcode images. This complete matrix barcode will be decoded to obtain the intact information (Information #3 in FIG. 1D). In the case where the image does not have a valid matrix barcode, the software sub-system can detect the absence of the matrix barcode. The absence of the matrix barcode at a certain wavelength of light may also become an information (Information #2 in FIG. 1D). The information reconstruction software sub-system can further analyze the information #1, #2, and #3 together to get the final information useful to various applications. It is possible because the layered multiple dimension matrix barcode is printed by a combination of various inks, and the matrix barcode scanner software system is aware of the expected images in all wavelengths.

One simplified example of the software system is shown in FIG. 1E. The matrix barcode is printed with a special infrared ink on top of the conventional black ink (shown on the left). The camera is equipped with an infrared filter, and the complete matrix barcode can be read. The camera takes and transmits the image data to the smartphone application for analysis. The smartphone application analyzes the image to detect an intact matrix barcode by showing the blue indicators (shown on the right).

A software system that can integrate several infrared images to obtain a useful information is used to operate the 3D-label scanner system and analyze the 3D-matrix barcode. In some embodiments, the software system includes instructions for one or more of the following:
a. merging the subset of matrix barcode patterns together from the images taken at different wavelengths.
b. combining the decoded matrix barcode information from each matrix barcode.
c. determining that a scanned matrix barcode image corresponds to a counterfeit matrix barcode by authenticating the spectral responses throughout the visible/infrared (for example, 400-1600 nm) region.

Traditional optical sensors, such as complementary metal-oxide-semiconductor (CMOS) sensors and charge modulation devices, suffer from dark current and a trade-off between a quantum efficiency and a weak channel modulation.

In addition, the problems are exacerbated when shortwave infrared light is to be detected. Traditional sensors made of silicon are not adequate for sensing and imaging shortwave infrared light (e.g., light within a wavelength range of 1400 nm to 3000 mm), because silicon is deemed to be transparent to light having a wavelength longer than 1100 nm (which corresponds with the bandgap of silicon).

Infrared sensors made of Indium Gallium Arsenide (InGaAs) and Germanium (Ge) suffer from high dark current. Many InGaAs and sensors are cooled to operate in a low temperature (e.g., −70° C.). However, cooling is disadvantageous for many reasons, such as cost of the cooling unit, an increased size of the device due to the cooling unit, an increased operation time for cooling the device, and increased power consumption for cooling the device.

Furthermore, traditional instruments for analyzing both visible light and infrared light typically have separate detectors and separate optical components for different wavelength ranges. For example, such instruments include visible light detectors and associated optical components for analyzing visible light and separately include infrared light detectors and associated optical components for analyzing infrared light. Such instruments are bulky, heavy, and expensive, which has limited applications of traditional instruments.

Devices, apparatuses, and methods that address the above problems are described herein. By providing apparatuses that include array detectors configured for converting both visible light and shortwave infrared light to electrical signals, compact, light, and reduced-cost devices and apparatuses can be provided for analyzing visible and shortwave infrared light. In some embodiments, such devices and apparatuses are used for hyperspectral imaging, thereby allowing spatial analysis of collected light (e.g., analysis of spatial distribution of collected light).

Reference will be made to certain embodiments, examples of which are illustrated in the accompanying drawings. While the underlying principles will be described in conjunction with the embodiments, it will be understood that it is not intended to limit the scope of claims to these particular embodiments alone. On the contrary, the claims are intended to cover alternatives, modifications and equivalents that are within the scope of the claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the underlying principles.

It will also be understood that, although the terms first, second, etc. may be used herein to describe various elements, these elements should not be limited by these terms. These terms are only used to distinguish one element from another. For example, a first image could be termed a second image, and, similarly, a second image could be termed a first image, without departing from the scope of the claims. The first image and the second image are both images, but they are not the same images.

The terminology used in the description of the embodiments herein is for the purpose of describing particular embodiments only and is not intended to limiting of the scope of claims. As used in the description and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

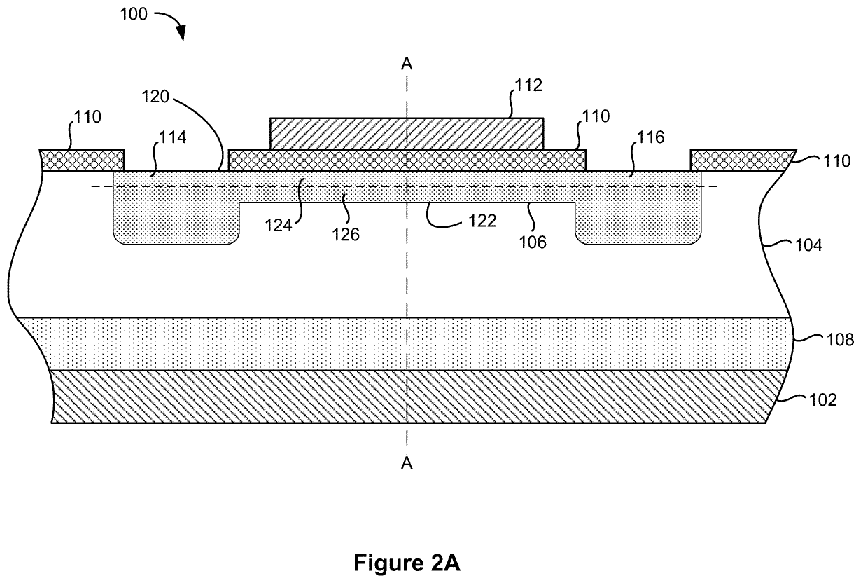

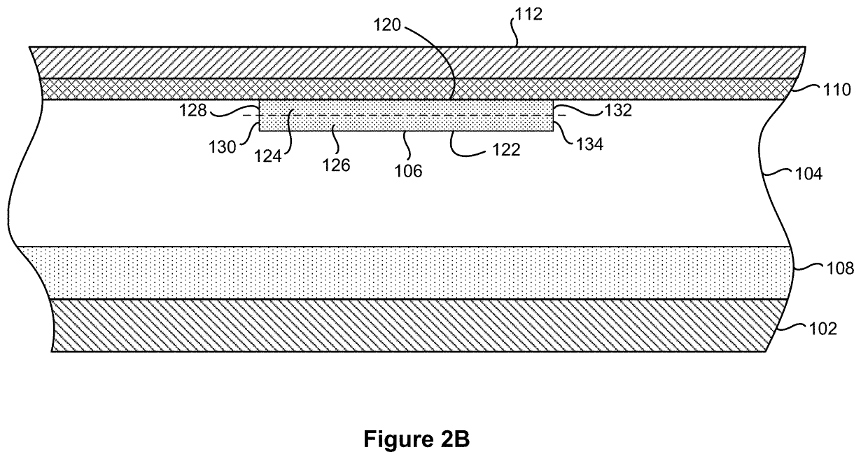

FIG. 2A is a partial cross-sectional view of a semiconductor optical sensor device 100 in accordance with some embodiments.

In some embodiments, the device 100 is called a gate-controlled charge modulated device (GCMD) (also called herein a gate-controlled charge modulation device).

The device 100 includes a first semiconductor region 104 doped with a dopant of a first type (e.g., an n-type semiconductor, such as phosphorus or arsenic) and a second semiconductor region 106 doped with a dopant of a second type (e.g., a high concentration of a p-type semiconductor, such as boron, which is often indicated using a p+ symbol). The second semiconductor region 106 is positioned above the first semiconductor region 104. The first type (e.g., n-type) is distinct from the second type (e.g., p-type). In some embodiments, the second semiconductor region 106 is positioned over the first semiconductor region 104.

The device includes a gate insulation layer 110 positioned above the second semiconductor region 106 and a gate 112 positioned above the gate insulation layer 110. In some embodiments, the gate insulation layer 110 is positioned over the second semiconductor region 106. In some embodiments, the gate insulation layer 110 is in contact with the second semiconductor region 106. In some embodiments, the gate 112 positioned over the gate insulation layer 110. In some embodiments, the gate 112 is in contact with the gate insulation layer 110.

The device also includes a source 114 electrically coupled with the second semiconductor region 106 and a drain 116 electrically coupled with the second semiconductor region 106.

The second semiconductor region 106 has a top surface 120 that is positioned toward the gate insulation layer 110. The second semiconductor region 106 also has a bottom surface 122 that is positioned opposite to the top surface 120 of the second semiconductor region 106. The second semiconductor region 106 has an upper portion 124 that includes the top surface 120 of the second semiconductor region 106. The second semiconductor region 106 also has a lower portion 126 that includes the bottom surface 122 of the second semiconductor region 106. The lower portion 126 is mutually exclusive with the upper portion 124. As used herein, the upper portion 124 and the lower portion 126 refer to different portions of the second semiconductor region 106. Thus, in some embodiments, there is no physical separation of the upper portion 124 and the lower portion 126. In some embodiments, the lower portion 126 refers to a portion of the second semiconductor region 106 that is not the upper portion 124. In some embodiments, the upper portion 124 has a thickness less than 1 nm, 2 nm, 3 nm, 4 nm, 5 nm, 6 nm, 7 nm, 8 nm, 9 nm, or 10 nm. In some embodiments, the upper portion 124 has a uniform thickness from the source 114 to the drain 116. In some embodiments, the upper portion 124 and the lower portion 126 have a same thickness at a horizontal location directly below the gate 112.

In some embodiments, the first type is an n-type and the second type is a p-type. For example, the first semiconductor region is doped with an n-type semiconductor and the source 114, the drain 116, and a channel between the source 114 and the drain 116 are doped with a p-type semiconductor, which is called a PMOS structure.

In some embodiments, the first type is a p-type and the second type is an n-type. For example, the first semiconductor region is doped with a p-type semiconductor and the source 114, the drain 116, and a channel between the source 114 and the drain 116 are doped with an n-type semiconductor, which is called an NMOS structure.

In some embodiments, the first semiconductor region 104 includes germanium. In some embodiments, the second semiconductor region 106 includes germanium. The direct band gap energy of germanium is around 0.8 eV at room temperature, which corresponds to a wavelength of 1550 nm. Thus, a semiconductor optical sensor device that includes germanium (e.g., in the first and second semiconductor regions) is more sensitive to shortwave infrared light than a semiconductor optical sensor device that includes silicon only (e.g., without germanium).

In some embodiments, the gate insulation layer 110 includes an oxide layer (e.g., SiO₂, GeOₓ, ZrOₓ, HfOₓ, SiₓN_{y}, SiₓO_{y}N_{z}, TaₓO_{y}, SrₓO_{y} or AlₓO_{y}). In some embodiments, the gate insulation layer 110 includes an oxynitride layer (e.g., SiON). In some embodiments, the gate insulation layer 110 includes a high-κ dielectric material, such as HfO₂, HfSiO, or Al₂O₃.

In some embodiments, the device includes a substrate insulation layer 108 positioned below the first semiconductor region 104. The substrate insulation layer includes one or more of: SiO₂, GeOₓ, ZrOₓ, HfOₓ, SiₓN_{y}, SiₓO_{y}N_{z}, TaₓO_{y}, SrₓO_{y} and AlₓO_{y}. In some embodiments, the substrate insulation layer 108 includes a high-κ dielectric material. In some embodiments, the first semiconductor region 104 is positioned over the substrate insulation layer 108. In some embodiments, the first semiconductor region 104 is in contact with the substrate insulation layer 108. In some embodiments, the substrate insulation layer 108 is positioned over the substrate 102 (e.g., a silicon substrate). In some embodiments, the substrate insulation layer 108 is in contact with the substrate 102.

In some embodiments, the device includes a third semiconductor region 108 that includes germanium doped with a dopant of the second type (e.g., p-type). The third semiconductor region 108 is positioned below the first semiconductor region 104.

In some embodiments, a doping concentration of the dopant of the second type in the second semiconductor region 106 is higher than a doping concentration of the dopant of the second type in the third semiconductor region 108. For example, the second semiconductor region 106 has a p+ doping (e.g., at a concentration of one dopant atom per ten thousand atoms or more) and the third semiconductor region 108 has a p doping (e.g., at a concentration of one dopant atom per hundred million atoms).

In some embodiments, the device includes a silicon substrate 102. For example, the third semiconductor region 108, the first semiconductor region 104, and the second semiconductor region 106 are formed over the silicon substrate 102.

In some embodiments, the gate 112 includes one or more of: polysilicon, amorphous silicon, silicon carbide, and metal. In some embodiments, the gate 112 consists of one or more of: polygermanium, amorphous germanium, polysilicon, amorphous silicon, silicon carbide, and metal.

In some embodiments, the second semiconductor region 106 extends from the source 114 to the drain 116.

In some embodiments, the first semiconductor region 104 extends from the source 114 to the drain 116.

In some embodiments, the gate insulation layer 110 extends from the source 114 to the drain 116.

In some embodiments, the second semiconductor region 106 has a thickness less than 100 nm. In some embodiments, the second semiconductor region 106 has a thickness between 1 nm than 100 nm. In some embodiments, the second semiconductor region 106 has a thickness between 5 nm than 50 nm. In some embodiments, the second semiconductor region 106 has a thickness between 50 nm than 100 nm. In some embodiments, the second semiconductor region 106 has a thickness between 10 nm than 40 nm. In some embodiments, the second semiconductor region 106 has a thickness between 10 nm than 30 nm. In some embodiments, the second semiconductor region 106 has a thickness between 10 nm than 20 nm. In some embodiments, the second semiconductor region 106 has a thickness between 20 nm than 30 nm. In some embodiments, the second semiconductor region 106 has a thickness between 30 nm than 40 nm. In some embodiments, the second semiconductor region 106 has a thickness between 40 nm than 50 nm.

In some embodiments, the first semiconductor region 104 has a thickness less than 1000 nm. In some embodiments, the first semiconductor region 104 has a thickness between 1 nm and 1000 nm. In some embodiments, the first semiconductor region 104 has a thickness between 5 nm and 500 nm. In some embodiments, the first semiconductor region 104 has a thickness between 500 nm and 1000 nm. In some embodiments, the first semiconductor region 104 has a thickness between 10 nm and 500 nm. In some embodiments, the first semiconductor region 104 has a thickness between 10 nm and 400 nm. In some embodiments, the first semiconductor region 104 has a thickness between 10 nm and 300 nm. In some embodiments, the first semiconductor region 104 has a thickness between 10 nm and 200 nm. In some embodiments, the first semiconductor region 104 has a thickness between 20 nm and 400 nm. In some embodiments, the first semiconductor region 104 has a thickness between 20 nm and 300 nm. In some embodiments, the first semiconductor region 104 has a thickness between 20 nm and 200 nm. In some embodiments, the first semiconductor region 104 has a thickness between 20 nm and 400 nm. In some embodiments, the first semiconductor region 104 has a thickness between 20 nm and 300 nm. In some embodiments, the first semiconductor region 104 has a thickness between 20 nm and 200 nm. In some embodiments, the first semiconductor region 104 has a thickness between 20 nm and 100 nm.

FIG. 2A also indicates plane AA upon which the view illustrated in FIG. 2B is taken.

FIG. 2B is a partial cross-sectional view of the semiconductor optical sensor device illustrated in FIG. 2A, in accordance with some embodiments.

In FIG. 2B, the first semiconductor region 104, the second semiconductor region 106, the gate insulation layer 110, the gate 112, the substrate insulation layer or third semiconductor region 108, and the substrate 102 are illustrated. For brevity, the description of these elements are not repeated herein.

As shown in FIG. 2B, the first semiconductor region 104 is in contact with both the upper portion 124 and the lower portion 126 of the second semiconductor region 106. The first semiconductor region 104 is in contact with the upper portion 124 of the second semiconductor region 106 at least at a location positioned under the gate 112. In some embodiments, the first semiconductor region 104 is in contact with the upper portion 124 of the second semiconductor region 106 at least at a location positioned directly under the gate 112. In some embodiments, the first semiconductor region 104 is in contact with the top surface 120 of the second semiconductor region 106 at least on an edge of the top surface 120 of the second semiconductor region 106. In some embodiments, the first semiconductor region 104 is in contact with the top surface 120 of the second semiconductor region 106 at least on an edge of the top surface 120 of the second semiconductor region 106 at a location directly under the gate 112.

In some embodiments, the second semiconductor region 106 has a first lateral surface (e.g., a combination of a lateral surface 128 of the upper portion 124 and a lateral surface 130 of the lower portion 126) that extends from the source 114 (FIG. 2A) to the drain 116 (FIG. 2A) and is distinct from the top surface 120 and the bottom surface 122. The second semiconductor region 106 has a second lateral surface (e.g., a combination of a lateral surface 132 of the upper portion 124 and a lateral surface 134 of the lower portion 126) that extends from the source 114 (FIG. 2A) to the drain 116 (FIG. 2A) and is distinct from the top surface 120 and the bottom surface 122. The first lateral surface and the second lateral surface are located on opposite sides of the second semiconductor region 106. In some embodiments, the first semiconductor region 104 is in contact with the upper portion 124 of the second semiconductor region 106 through a portion 128 of the first lateral surface. In some embodiments, the first semiconductor region 104 is in contact with the upper portion 124 of the second semiconductor region 106 through a portion 132 of the second lateral surface. In some embodiments, the first semiconductor region 104 is in contact with the upper portion 124 of the second semiconductor region 106 through a portion 128 of the first lateral surface at a location directly under the gate 112 and the first semiconductor region 104 is also in contact with the upper portion 124 of the second semiconductor region 106 through a portion 132 of the second lateral surface at a location directly under the gate 112.

In some embodiments, the lateral surface 128 of the upper portion 124 has a thickness less than 1 nm, 2 nm, 3 nm, 4 nm, 5 nm, 6 nm, 7 nm, 8 nm, 9 nm, or 10 nm. In some embodiments, the lateral surface 132 of the upper portion 124 has a thickness less than 1 nm, 2 nm, 3 nm, 4 nm, 5 nm, 6 nm, 7 nm, 8 nm, 9 nm, or 10 nm. In some embodiments, the lateral surface 128 of the upper portion 124 has a thickness less a thickness of the lateral surface 130 of the lower portion 126. In some embodiments, the lateral surface 132 of the upper portion 124 has a thickness less a thickness of the lateral surface 134 of the lower portion 126.

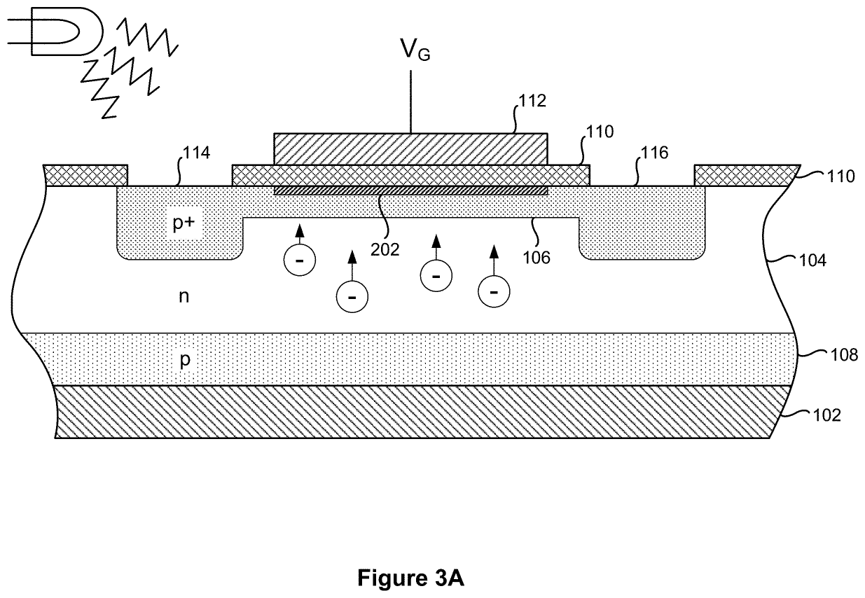

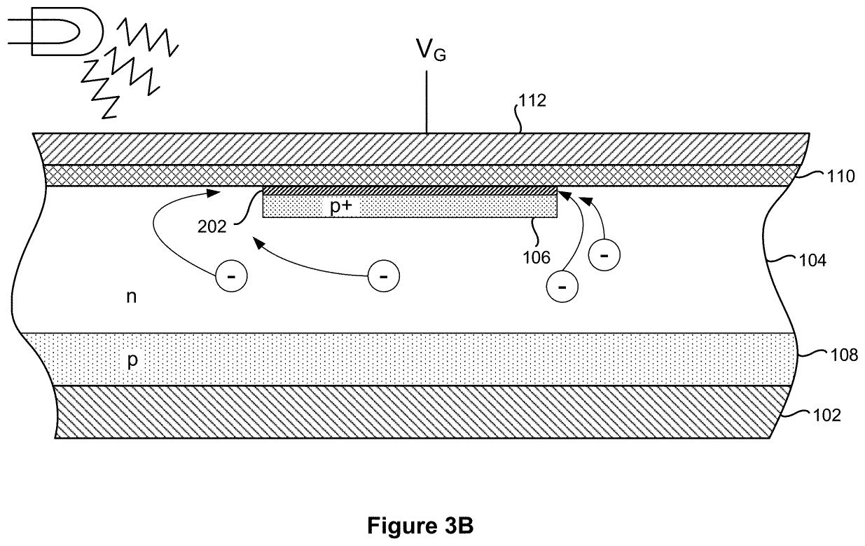

FIGS. 3A-3B are used below to illustrate operational principles of the semiconductor optical sensor device in accordance with some embodiments. However, FIGS. 3A-3B and the described principles are not intended to limit the scope of claims.

FIG. 3A is a schematic diagram illustrating an operation of a semiconductor optical sensor device in accordance with some embodiments.

The device illustrated in FIG. 3A is similar the device illustrated in FIG. 2A. For brevity, the description of the elements described above with respect to FIG. 2A is not repeated herein.

In FIG. 3A, the first semiconductor region 104 is doped with an n-type semiconductor. The second semiconductor region 106 is heavily doped with a p-type semiconductor. The third semiconductor region 108 is doped with a p-type semiconductor. In some embodiments, the third semiconductor region 108 is lightly doped with the p-type semiconductor.

While voltage VG is applied to the gate 112, a potential well 202 is formed between the second semiconductor region 106 and the gate insulation layer 110. While the device (in particular, the first semiconductor region 104) is exposed to light, photo-generated carriers are generated. While voltage VG is applied to the gate 112, the photo-generated carriers migrate to the potential well 202.

FIG. 3B is a schematic diagram illustrating the operation of the semiconductor optical sensor device illustrated in FIG. 3A, in accordance with some embodiments.

FIG. 3B is similar to FIG. 3A. For brevity, the description of the same elements described above with respect to FIG. 2B is not repeated herein.

In FIG. 3B, the migration path of the photo-generated carriers to the potential well 202 located between the second semiconductor region 106 and the gate insulation layer 110 is indicated. The photo-generated carriers get into the potential well 202 through lateral surfaces of second semiconductor region 106. In some embodiments, at least a portion of the photo-generated carriers directly pass through a bottom surface of the second semiconductor region 106 to reach the potential well 202. This is possible because the second semiconductor region 106 is thin and the barrier between the second semiconductor region 106 and the potential well 202 is low (e.g., less than band gap of Ge). When the photo-generated carriers migrate through the bottom surface of the second semiconductor region 106, carrier recombination may take place in the second semiconductor region 106.

This direct contact between the first semiconductor region 104 and the potential well 202 significantly increases migration of the photo-generated carriers from the first semiconductor region 104 to the potential well 202. Thus, a thick first semiconductor region 104 may be used for increasing the quantum efficiency, while the photo-generated carriers are effectively transported to the potential well 202 for increasing the on/off signal modulation.

In the absence of an exposure to light, the device would have a certain drain current (called herein Ioff). However, when the device is exposed to light, the photo-generated carriers modulate the drain current (e.g., the drain current increases to Ion).

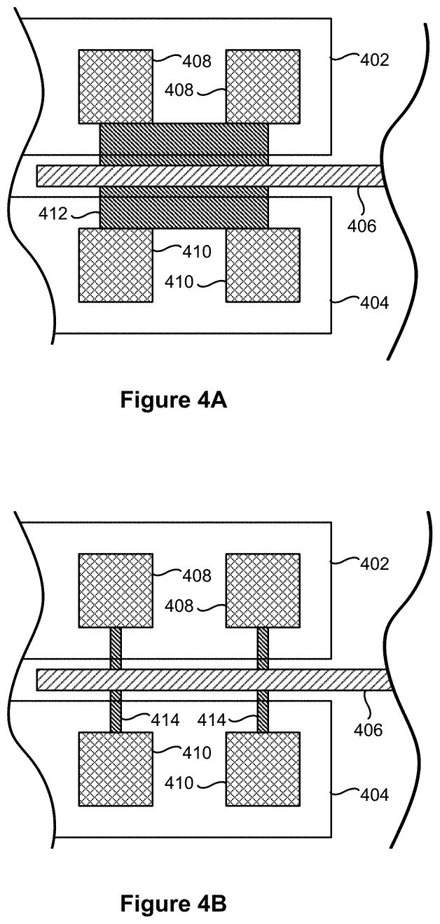

FIGS. 4A and 4B are schematic diagrams illustrating a single channel configuration and a multi-channel configuration of a semiconductor optical sensor device. The schematic diagrams in FIGS. 4A and 4B are based on top-down views of the semiconductor optical sensor device. However, it should be noted that the schematic diagrams in FIGS. 4A and 4B are used to represent relative sizes and positions of various elements and that the schematic diagrams in FIGS. 4A and 4B are not cross-sectional views.

FIG. 4A is a schematic diagram illustrating a single channel configuration of a semiconductor optical sensor device in accordance with some embodiments.

FIG. 4A illustrates that the device has a gate 406, a source 402, and a drain 404. The device also includes a channel 412 that extends from the source 402 to the drain 404. The channel 412 is typically defined by the second semiconductor region. For example, the shape of the channel 412 is determined by a pattern of ion implantation in forming the second semiconductor region. The source 402 has multiple contacts 408 with the channel 412 and the drain 404 has multiple contacts 410 with the channel 412.

FIG. 4B is a schematic diagram illustrating a multi-channel configuration of a semiconductor optical sensor device in accordance with some embodiments.

FIG. 4B is similar to FIG. 4A except that the device has multiple channels 414 between the source 402 and the drain 404. In some embodiments, the second semiconductor region defines multiple channels 414 between the source 402 and the drain 404. Each channel 414 in FIG. 4B connects a single contact 408 of the source 402 and a single contact 410 of the drain 404. Thus, a width of the channel 414 in FIG. 4B is less than a width of the channel 412 in FIG. 4A. The reduced width of a channel is believed to facilitate a transfer of a photo-generated carrier to a large capacitance region (e.g., an interface of the second semiconductor region and the gate insulation layer) of the device.

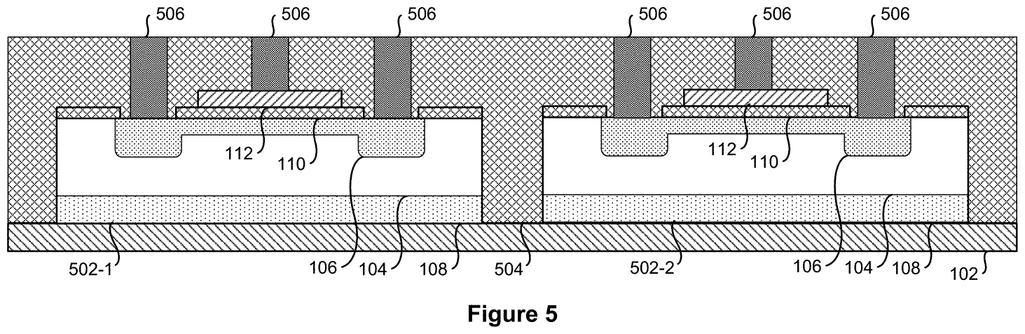

FIG. 5 is a partial cross-sectional view of semiconductor optical sensor devices in accordance with some embodiments.

FIG. 5 illustrates that a plurality of semiconductor optical sensor devices (e.g., devices 502-1 and 502-2) are formed on a common substrate. The multiple devices form a sensor array. Although FIG. 5 illustrates two semiconductor optical sensor devices, the sensor array may include more than two semiconductor optical sensor devices. In some embodiments, the sensor array includes a two-dimensional array of semiconductor optical sensor devices.

FIG. 5 also illustrates that vias 506 are formed to connect the gate 112, the source, and the drain of the devices 502-1 and 502-2.

In some embodiments, the plurality of devices (e.g., devices 502-1 and 502-2) has the first semiconductor region 104 on a common plane. In some embodiments, the first semiconductor region 104 of the plurality of devices is formed concurrently (e.g., using epitaxial growth of the first semiconductor region 104).

In some embodiments, the plurality of devices (e.g., devices 502-1 and 502-2) has the second semiconductor region 106 on a common plane. In some embodiments, the second semiconductor region 106 of the plurality of devices is formed concurrently (e.g., using ion implantation).

In some embodiments, the plurality of devices (e.g., devices 502-1 and 502-2) has the third semiconductor region 108 on a common plane. In some embodiments, the third semiconductor region 108 of the plurality of devices is formed concurrently (e.g., using epitaxial growth of germanium islands).

In some embodiments, the plurality of devices is separated by one or more trenches. For example, the device 502-1 and the device 502-2 are separate by a trench. In some embodiments, the one or more trenches are filled with an insulator. In some embodiments, a trench is a shallow trench isolator.

In some embodiments, the plurality of devices is positioned on separate germanium islands formed on the common silicon substrate 102. For example, in some embodiments, third semiconductor regions 108 (e.g., germanium islands) are formed on the substrate 102 and the rest of devices 502-1 and 502-2 are formed over the third semiconductor regions 108.

In some embodiments, the sensor array includes a passivation layer over the plurality of devices. For example, the passivation layer 504 is positioned over the devices 502-1 and 502-2 in FIG. 5.

In some embodiments, the sensor array includes a passivation layer 504 between the plurality of devices. For example, the passivation layer 504 is positioned between the devices 502-1 and 502-2 in FIG. 5.

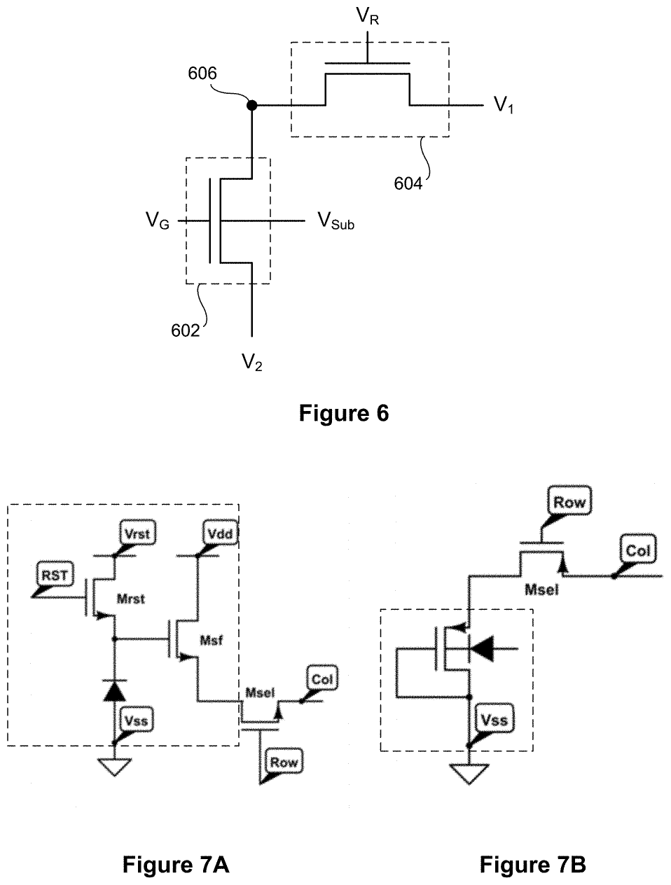

FIG. 6 illustrates an exemplary sensor circuit in accordance with some embodiments.

The sensor circuit includes a photo-sensing element 602. The photo-sensing element 602 has a source terminal, a gate terminal, a drain terminal, and a body terminal. The sensor circuit also includes a selection transistor 604 having a source terminal, a gate terminal, and a drain terminal. In some embodiments, the drain terminal of the selection transistor 604 is electrically coupled (e.g., at a point 606) with the source terminal of the photo-sensing element 602. In some embodiments, the source terminal of the selection transistor 604 is electrically coupled (e.g., at the point 606) with the drain terminal of the photo-sensing element 602.

In some embodiments, the photo-sensing element is a GCMD (e.g., the device 100, FIG. 2A).

In some embodiments, the source terminal or the drain terminal, of the photo-sensing element 602, that is not electrically coupled with the source terminal or the drain terminal of the selection transistor 604 is connected to a ground. For example, V₂ is connected to a ground.

In some embodiments, the source terminal or the drain terminal, of the photo-sensing element 602, that is electrically coupled with the source terminal or the drain terminal of the selection transistor 604 is not connected to a ground. For example, the point 606 is not connected to a ground.

In some embodiments, the source terminal or the drain terminal, of the photo-sensing element 602, that is not electrically coupled with the source terminal or the drain terminal of the selection transistor 604 is electrically coupled with a first voltage source. For example, V₂ is connected to the first voltage source.

In some embodiments, the first voltage source provides a first fixed voltage, such as a voltage that is distinct from the ground.

In some embodiments, the source terminal or the drain terminal, of the selection transistor 604, that is not electrically coupled with the source terminal or the drain terminal of the photo-sensing element 620 is electrically coupled with a second voltage source. For example, V₁ is connected to the second voltage source. In some embodiments, the second voltage source provides a second fixed voltage.

In some embodiments, the sensor circuit includes no more than two transistors, the two transistors including the selection transistor 604. In some embodiments, the sensor circuit also includes a gate control transistor that is electrically coupled to the gate of the photo-sensing element.

In some embodiments, the sensor circuit includes no more than one transistor, the one transistor being the selection transistor 604.

The sensor circuit in FIG. 6 is called herein one-transistor modified active-pixel sensor (1T-MAPS), because the sensor circuit includes a single transistor and a modified active-pixel sensor. The difference between 1T-MAPS and a conventional sensor circuit called three-transistor active-pixel sensor (3T-APS) is described below with respect to FIGS. 7A-7B.

FIG. 7A illustrates an exemplary 3T-APS circuit in accordance with some embodiments.

The 3T-APS circuit includes a photo-sensing element (e.g., a photodiode) and three transistors: a reset transistor Mrst, a source-follower transistor Msf, and a select transistor Msel.

The reset transistor Mrst works as a reset switch. For example, Mrst receives a gate signal RST, which allows a reset voltage, Vrst, to be provided to the photo-sensing element to reset the photo-sensing element.

The source-follower transistor Msf acts as a buffer. For example, Msf receives an input (e.g., a voltage input) from the photo-sensing element, which allows a high voltage Vdd to be output to the source of the select transistor Msel.

The select transistor Msel works as a readout switch. For example, Msel receives a row selection signal ROW, which allows an output from the source-follower transistor Msf to be provided to a column line.

FIG. 7B illustrates an exemplary 1T-MAPS circuit in accordance with some embodiments.

As explained above with respect to FIG. 6, the 1T-MAPS circuit includes one photo-sensing element (e.g., GCMD) and one transistor, namely a select transistor Msel.

The select transistor Msel receives a row selection signal ROW, which allows a current from the column line to flow to an input of the photo-sensing element. Alternatively, the row selection signal ROW, provided to the select transistor Msel, allows a current from the photo-sensing element to flow to the column line. In some embodiments, the column line is set to a fixed voltage.

In some embodiments, the 1T-MAPS circuit does not require a reset switch, because photo-generated carriers stored in the GCMD dissipate in a short period of time (e.g., 0.1 second).

A comparison of the 3T-APS circuit illustrated in FIG. 7A and the 1T-MAPS circuit illustrated in FIG. 7B shows that the 1T-MAPS circuit has a much smaller size than the 3T-APS circuit. Thus, a 1T-MAPS circuit is more cost advantageous than a 3T-APS circuit made of a same material. In addition, due to the smaller size, more 1T-MAPS circuits can be placed on a same area of a die than 3T-APS circuits, thereby increasing a number of pixels on the die.

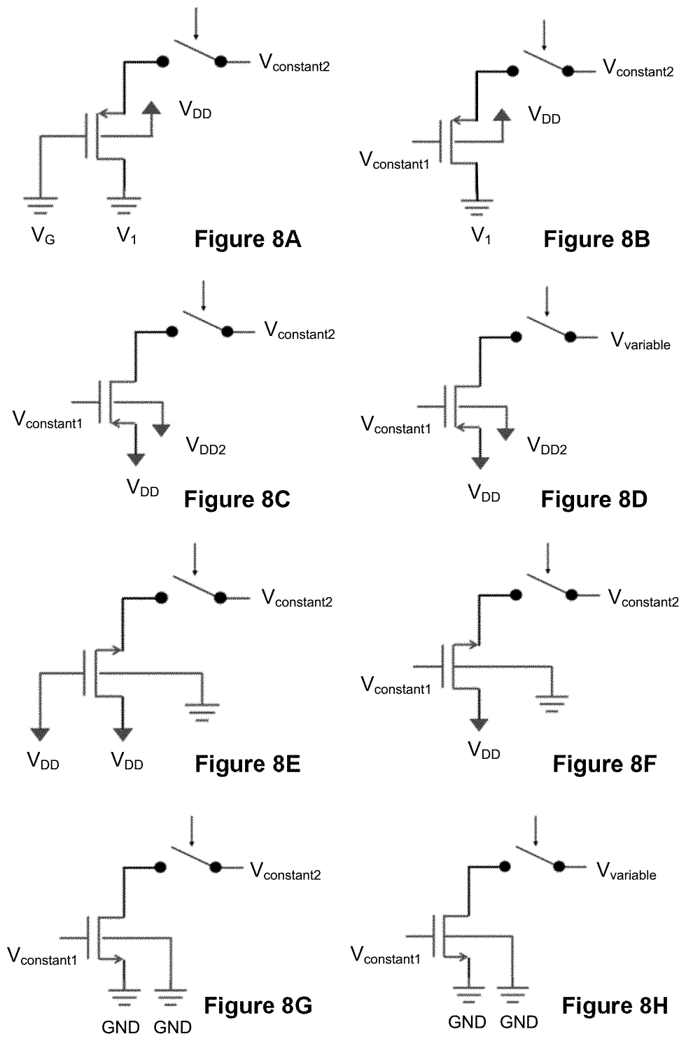

FIGS. 8A-8H illustrate exemplary sensor circuits in accordance with some embodiments. In FIGS. 8A-8H, a switch symbol represents a select transistor.

FIGS. 8A-8D illustrate exemplary sensor circuits that include a PMOS-type GCMD.

In FIG. 8A, the gate of the GCMD is connected to a ground VG, and the drain of the GCMD is connected to a low voltage source V₁ (e.g., ground). The source of the GCMD is connected to a switch (or a select transistor), which is connected to a fixed voltage, V_{constant2}. In some embodiments, the body is connected to a high voltage source VDD.

In FIG. 8B, the gate of the GCMD is connected to a fixed voltage V_{constant1}, and the drain of the GCMD is connected to a low voltage source V₁ (e.g., ground). The source of the GCMD is connected to a switch (or a select transistor), which is connected to a fixed voltage, V_{constant2}. In some embodiments, the body is connected to a high voltage source VDD.

In FIG. 8C, the gate of the GCMD is connected to a fixed voltage V_{constant1}, and the source of the GCMD is connected to a high voltage source VDD. The drain of the GCMD is connected to a switch (or a select transistor), which is connected to a fixed voltage, V_{constant2}. In some embodiments, the body is connected to a high voltage source V_{DD2}.

In FIG. 8D, the gate of the GCMD is connected to a fixed voltage V_{constant1}, and the source of the GCMD is connected to a high voltage source VDD. The drain of the GCMD is connected to a switch (or a select transistor), which is connected to a variable voltage, V_{variable}. In some embodiments, the body is connected to a high voltage source V_{DD2}.

FIGS. 8E-8H illustrate exemplary sensor circuits that include NMOS type GCMD.

In FIG. 8E, the gate and the drain of the GCMD are connected to a high voltage source VDD. The source of the GCMD is connected to a switch (or a select transistor), which is connected to a fixed voltage, V_{constant2}. In some embodiments, the body is connected to a ground.

In FIG. 8F, the gate of the GCMD is connected to a fixed voltage V_{constant1}, and the drain of the GCMD is connected to a high voltage source VDD. The source of the GCMD is connected to a switch (or a select transistor), which is connected to a fixed voltage, V_{constant2}. In some embodiments, the body is connected to a ground.

In FIG. 8G, the gate of the GCMD is connected to a fixed voltage V_{constant1}, and the source of the GCMD is connected to a ground. The drain of the GCMD is connected to a switch (or a select transistor), which is connected to a fixed voltage, V_{constant2}. In some embodiments, the body is connected to a ground.

In FIG. 8H, the gate of the GCMD is connected to a fixed voltage V_{constant1}, and the source of the GCMD is connected to a ground. The drain of the GCMD is connected to a switch (or a select transistor), which is connected to a variable voltage, V_{variable}. In some embodiments, the body is connected to a ground.

In FIGS. 8A-8H, the drain current in the GCMD changes depending on whether the GCMD is exposed to light. Thus, in some embodiments, the GCMD is modeled as a current source that provides Ion when the GCMD is exposed to light and provide I_{off} when the GCMD is not exposed to light.

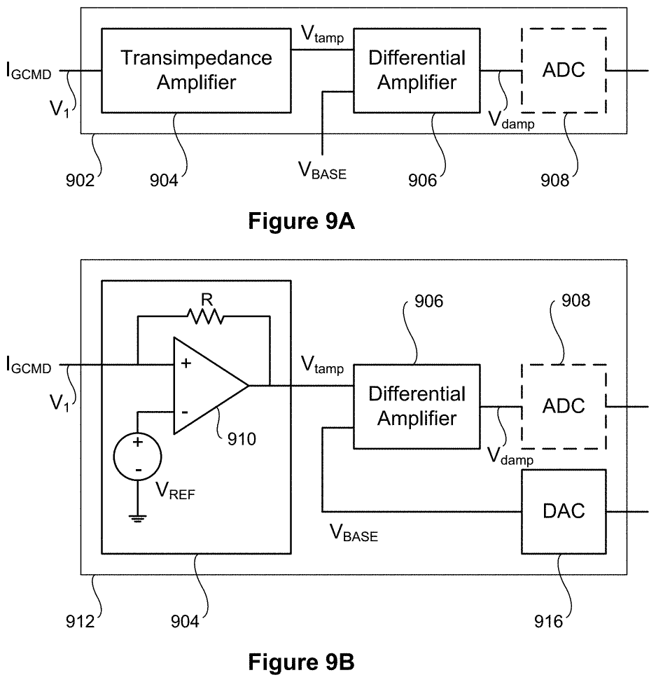

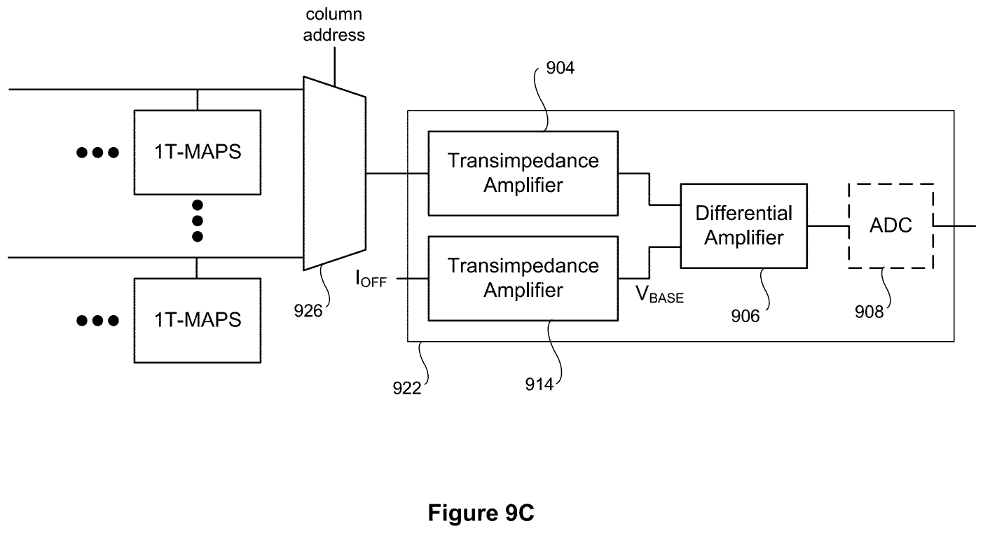

FIGS. 9A-9C illustrate exemplary converter circuits in accordance with some embodiments.

FIG. 9A illustrates an exemplary converter circuit 902 in accordance with some embodiments.

The converter circuit 902 includes a first transimpedance amplifier 904 (e.g., an operational amplifier) that has an input terminal (e.g., an input terminal receiving I_{GCMD} from the photo-sensing element, such as the GCMD) electrically coupled with the source terminal or the drain terminal of the selection transistor of a first sensor circuit (e.g., the sensor circuit in FIG. 6), that is not electrically coupled with the source terminal or the drain terminal of the photo-sensing element (e.g., the terminal having a voltage V₁ in FIG. 6). The first transimpedance amplifier 904 is configured to convert a current input (e.g., I_{GCMB}) from the photo-sensing element into a voltage output (e.g., Vₜₐₘₚ).

The converter circuit 902 also includes a differential amplifier 906 having two input terminals. A first input terminal of the two input terminals is electrically coupled with the voltage output (e.g., Vₜₐₘₚ) of the first transimpedance amplifier 904 and a second input terminal of the two input terminals is electrically coupled with a voltage source that is configured to provide a voltage (e.g., V_{BASE}) corresponding to a base current provided by the photo-sensing element. The differential amplifier is configured to output a voltage (e.g., V_{damp}) based on a voltage difference between the voltage output (e.g., Vₜₐₘₚ) and the voltage provided by the voltage source (e.g., V_{BASE}). In some embodiments, the differential amplifier 906 includes an operational amplifier. In some embodiments, the differential amplifier 906 includes a transistor long tailed pair.

In some embodiments, the converter circuit 922 includes an analog-to-digital converter 908 electrically coupled to an output of the differential amplifier 906 (e.g., Vₜₐₘₚ), the analog-to-digital converter configured to convert the output (e.g., a voltage output) of the differential amplifier 906 (e.g., Vₜₐₘₚ) into a digital signal.

FIG. 9B illustrates an exemplary converter circuit 912 in accordance with some embodiments. The converter circuit 912 is similar to the converter circuit 902 illustrated in FIG. 9A. Some of the features described with respect to FIG. 9A are applicable to the converter circuit 912. For brevity, the description of such features is not repeated herein.

FIG. 9B illustrates that, in some embodiments, the first transimpedance amplifier 904 in the converter circuit 912 includes an operational amplifier 910. The operational amplifier 910 has a non-inverting input terminal that is electrically coupled with the source terminal or the drain terminal of the selection transistor of the first sensor circuit (E.g., the terminal having a voltage V₁ in FIG. 6). The operational amplifier 910 also has an inverting input terminal that is electrically coupled with a reference voltage source that provides a reference voltage V_{REF}. The operational amplifier 910 has an output terminal, and a resistor with a resistance value R is electrically coupled to the non-inverting input terminal on a first end of the resistor and to the output terminal on the second end, opposite to the first end, of the resistor.

In operation, the voltage output Vₜₐₘₚ is determined as follows:

Vₜₐₘₚ=V_{REF}+R·I_{GCMD}

Furthermore, the current from the GCMD can be modeled as follows:

I_{GCMD}=I_{off} (no light)

I_{GCMD}=I_{Δ}+I_{off} (light)

In some embodiments, the base current corresponds to a current provided by the photo-sensing element while the photo-sensing element receives substantially no light (e.g., I_{off}). When I_{off} is converted by the first transimpedance amplifier 904, a corresponding voltage V_{BASE} is determined as follows:

V_{BASE}=V_{REF}+R·I_{off}

Then, the voltage difference between Vₜₐₘₚ and V_{BASE} is as follows:

Vₜₐₘₚ−V_{BASE}=R·I_{Δ}

The voltage output V_{damp} of the differential amplifier 906 is as follows:

Vdamp=A·R·I_{Δ}

where A is a differential gain of the differential amplifier 906. In some embodiments, the differential gain is one of: one, two, three, five, ten, twenty, fifty, and one hundred.

FIG. 9B also illustrates that, in some embodiments, the voltage source is a digital-to-analog converter (DAC) 916. For example, the DAC 916 is configured to provide VBASE.

FIG. 9C illustrates an exemplary converter circuit 922 in accordance with some embodiments. The converter circuit 922 is similar to the converter circuit 902 illustrated in FIG. 9A and the converter circuit 912 illustrated in FIG. 9B. Some of the features described with respect to FIGS. 9A and 9B are applicable to the converter circuit 922. For example, in some embodiments, the converter circuit 922 includes the digital-to-analog converter 916. In some embodiments, the first transimpedance amplifier 904 includes an operational amplifier 910. For brevity, the description of such features is not repeated herein.

FIG. 9C illustrates that the voltage source (that provides VBASE) is a second transimpedance amplifier 914 having an input terminal electrically coupled with a second sensor circuit that is distinct from the first sensor circuit. In some embodiments, the input terminal of the second transimpedance amplifier 914 is electrically coupled with the source terminal or the drain terminal of the selection transistor of the second sensor circuit. In some embodiments, the photo-sensing element of the second sensor circuit is optically covered so that the photo-sensing element of the second sensor circuit is prevented from receiving light. Thus, the second sensor circuit provides Ioff to the second transimpedance amplifier 914. The second transimpedance amplifier 914 converts Ioff to VBASE. In some embodiments, the second transimpedance amplifier 914 includes an operational amplifier.

In some embodiments, the first transimpedance amplifier 904 is configured to electrically couple with a respective sensor circuit of a plurality of sensor circuits through a multiplexer. For example, the converter circuit 922 is coupled to a multiplexer 926. The multiplexer receives a column address to select one of a plurality of column lines. Each column line is connected to multiple sensor circuits, each having a selection transistor that receives a ROW signal. Thus, based on a column address and a ROW signal, one sensor circuit in a two-dimensional array of sensor circuits is selected, and a current output from the selected sensor circuit is provided to the first transimpedance amplifier 904 through the multiplexer 926.

Although FIGS. 9A-9C illustrate selected embodiments, it should be noted that a converter circuit may include a subset of the features described in FIGS. 9A-9C (e.g., the converter circuit 922 may be coupled with the multiplexer 926 without having the second transimpedance amplifier 914). In some embodiments, a converter circuit includes additional features not described with respect to FIGS. 9A-9C.

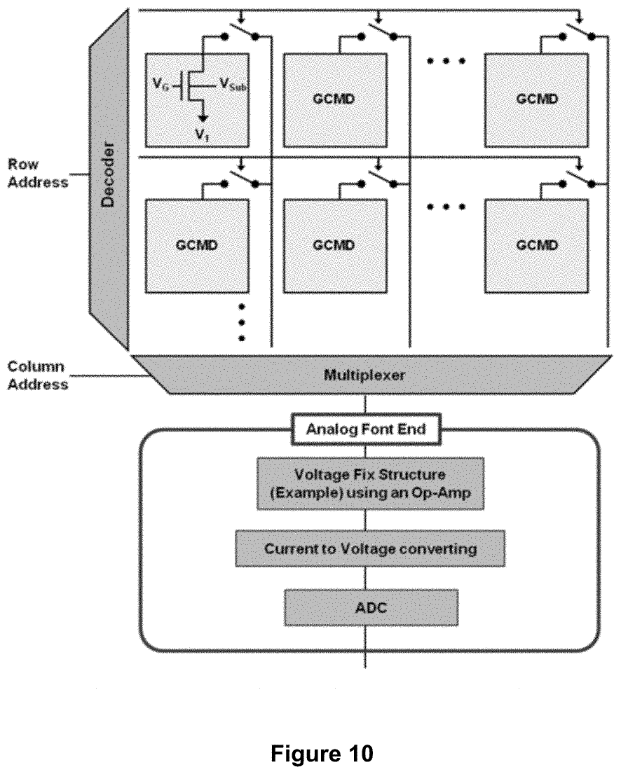

FIG. 10 illustrates an exemplary image sensor device in accordance with some embodiments.

In accordance with some embodiments, the image sensor device includes an array of sensors. A respective sensor in the array of sensors includes a sensor circuit (e.g., FIGS. 8A-8H).

In some embodiments, the image sensor device includes a converter circuit (e.g., FIGS. 9A-9C).

In some embodiments, the array of sensors includes multiple rows of sensors (e.g., at least two rows of sensors are illustrated in FIG. 10). For sensors in a respective row, gate terminals of selection transistors are electrically coupled to a common selection line. For example, as shown in FIG. 10, gate terminals of sensor circuits in a top row are electrically coupled to a same signal line.

In some embodiments, the array of sensors includes multiple columns of sensors (e.g., at least three columns of sensors are illustrated in FIG. 10). For sensors in a respective column, one of source terminals or drain terminals of selection transistors (i.e., either the source terminals of the selection transistors or the drain terminals of the selection transistors) are electrically coupled to a common column line. For example, as shown in FIG. 10, the drain terminals of the selection transistors in a left column of sensors are electrically coupled to a same column line.

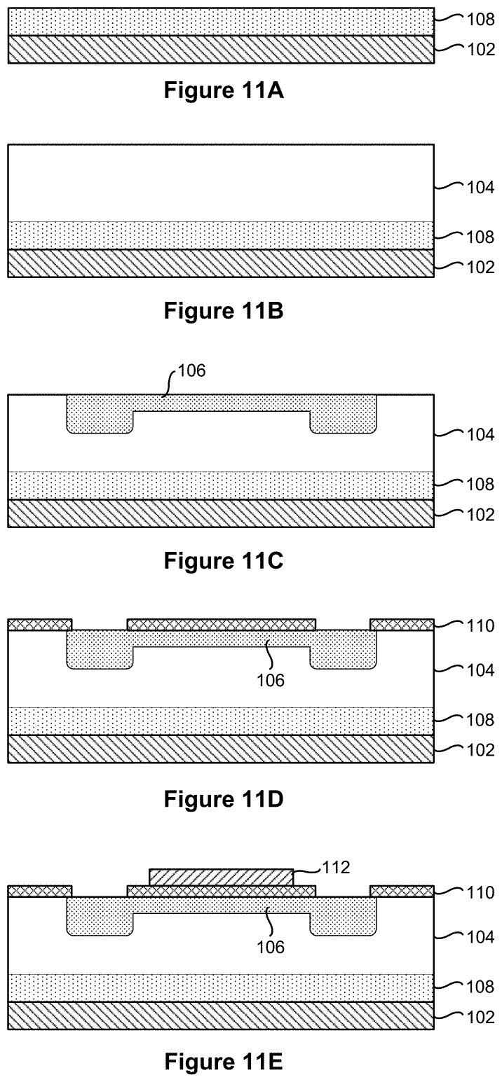

FIGS. 11A-11E illustrates an exemplary method for making a semiconductor optical sensor device in accordance with some embodiments.

FIG. 11A illustrates forming the semiconductor optical sensor device includes forming a third semiconductor region 108 on a silicon substrate 102. In some embodiments, the third semiconductor region 108 is epitaxially grown on the substrate 102.

FIG. 11B illustrates forming a first semiconductor region 104, above the silicon substrate 102, doped with a dopant of a first type.

In some embodiments, the first semiconductor region 104 is formed by epitaxially growing the first semiconductor region 104.

In some embodiments, the first semiconductor region 104 is doped in-situ with the dopant of the first type (e.g., n-type) while the first semiconductor region 104 is grown.

In some embodiments, the first semiconductor region 104 is doped with the dopant of the first type (e.g., n-type) using an ion implantation process or a gas phase diffusion process. In some embodiments, the first semiconductor region 104 is doped with the dopant of the first type (e.g., n-type) using an ion implantation process. In some embodiments, the first semiconductor region 104 is doped with the dopant of the first type (e.g., n-type) using a gas phase diffusion process.

FIG. 11C illustrates forming a second semiconductor region 106, above the silicon substrate 102, doped with a dopant of a second type. The second semiconductor region 106 is positioned above the first semiconductor region 104. The first type (e.g., n-type) is distinct from the second type (e.g., p-type).

In some embodiments, the second semiconductor region 106 is formed by epitaxially growing the second semiconductor region 106.

In some embodiments, the second semiconductor region 106 is doped in-situ with the dopant of the second type (e.g., p-type, and in particular, p+) while the second semiconductor region 106 is grown.

In some embodiments, the second semiconductor region 106 is doped with the dopant of the second type (e.g., p-type, and in particular, p+) using an ion implantation process or a gas phase diffusion process. In some embodiments, the second semiconductor region 106 is doped with the dopant of the second type (e.g., p-type, and in particular, p+) using an ion implantation process. In some embodiments, the second semiconductor region 106 is doped with the dopant of the second type (e.g., p-type, and in particular, p+) using a gas phase diffusion process.

In some embodiments, the second semiconductor region 106 is doped with the dopant of the second type (e.g., p-type, and in particular, p+) using an ion implantation process after the first semiconductor region 104 is doped with the dopant of the first type using an ion implantation process or a gas phase diffusion process. In some embodiments, the second semiconductor region 106 is doped with the dopant of the second type (e.g., p-type, and in particular, p+) using an ion implantation process after the first semiconductor region 104 is doped with the dopant of the first type using an ion implantation process. In some embodiments, the second semiconductor region 106 is doped with the dopant of the second type (e.g., p-type, and in particular, p+) using an ion implantation process after the first semiconductor region 104 is doped with the dopant of the first type using a gas phase diffusion process.

FIG. 11D illustrates forming a gate insulation layer 110 above the second semiconductor region 106. One or more portions of the second semiconductor region 106 are exposed from the gate insulation layer 110 to define a source and a drain. For example, the gate insulation layer 110 is pattern etched (e.g., using a mask) to expose the source and the drain.

As described with respect to FIGS. 2A and 2B, the second semiconductor region 106 has a top surface that faces the gate insulation layer 110. The second semiconductor region 106 has a bottom surface that is opposite to the top surface of the second semiconductor region 106. The second semiconductor region 106 has an upper portion that includes the top surface of the second semiconductor region 106. The second semiconductor region 106 has a lower portion that includes the bottom surface of the second semiconductor region 106 and is mutually exclusive with the upper portion. The first semiconductor region 104 is in contact with both the upper portion and the lower portion of the second semiconductor region 106. The first semiconductor region 104 is in contact with the upper portion of the second semiconductor region 106 at least at a location positioned under the gate 112.

FIG. 11E illustrates forming a gate 112 positioned above the gate insulation layer 110.

In some embodiments, a method of forming a sensor array includes concurrently forming a plurality of devices on a common silicon substrate. For example, third semiconductor regions of multiple devices may be formed concurrently in a single epitaxial growth process. Subsequently, first semiconductor regions of the multiple devices may be formed concurrently in a single epitaxial growth process. Thereafter, second semiconductor regions of the multiple devices may be formed concurrently in a single ion implantation process. Similarly, gate insulation layers of the multiple devices may be formed concurrently, and gates of the multiple devices may be formed concurrently.

In accordance with some embodiments, a method for sensing light includes exposing a photo-sensing element (e.g., GCMD in FIG. 6) to the light.

The method also includes providing a fixed voltage to the source terminal of the photo-sensing element (e.g., by applying a fixed voltage V₁ and applying VR to the selection transistor 604 (FIG. 6). Based on an intensity of light on the GCMD, a drain current of the GCMD changes.

In some embodiments, the method includes determining an intensity of the light based on the drain current of the photo-sensing element (e.g., GCMD). A change in the drain current indicates whether light is detected by the photo-sensing element.

In some embodiments, measuring the drain current includes converting the drain current to a voltage signal (e.g., converting the drain current I_{GCMD} to Vₜₐₘₚ, FIG. 9A).

In some embodiments, converting the drain current to the voltage signal includes using a transimpedance amplifier (e.g., transimpedance amplifier 904, FIG. 9A) to convert the drain current to the voltage signal.

In some embodiments, measuring the drain current includes using any converter circuit described herein (e.g., FIGS. 9A-9C).

In some embodiments, the method includes activating the selection transistor of the sensor circuit (e.g., the selection transistor 604, FIG. 6). Activating the selection transistor allows a drain current to flow through the selection transistor, thereby allowing a measurement of the drain current.

In some embodiments, the fixed voltage is provided to the source terminal of the photo-sensing element prior to exposing the photo-sensing element to light. For example, in FIG. 6, the selection transistor 604 is activated before exposing the photo-sensing element 602 to light.

In some embodiments, the fixed voltage is provided to the source terminal of the photo-sensing element subsequent to exposing the photo-sensing element to light. For example, in FIG. 6, the selection transistor 604 is activated after exposing the photo-sensing element 602 to light.

In accordance with some embodiments, a method for detecting an optical image includes exposing any array of sensors described herein (e.g., FIG. 10) to a pattern of light.

The method also includes, for a photo-sensing element of a respective sensor in the array of sensors, providing a respective voltage to the source terminal of the photo-sensing element of the respective image sensor. For example, a selection transistor (e.g., the selection transistor 604, FIG. 6) of the respective sensor is activated to provide the respective voltage, thereby allowing a measurement of a drain current of the respective sensor.

The method further includes measuring a drain current of the photo-sensing element (e.g., the photo-sensing element 602).

In some embodiments, the source terminals of the photo-sensing elements in the array of sensors concurrently receive respective voltages. For example, respective voltages are concurrently applied to multiple photo-sensing elements (e.g., photo-sensing elements in a same row) for a concurrent reading of the multiple photo-sensing elements.

In some embodiments, the source terminals of the photo-sensing elements in the array of sensors sequentially receive respective voltages. For example, respective voltages are sequentially applied to multiple photo-sensing elements (e.g., photo-sensing elements in a same column) for sequential reading of the multiple photo-sensing elements.

In some embodiments, the source terminals of photo-sensing elements in the array of sensors receive a same voltage.

In some embodiments, the drain currents of the photo-sensing elements in the array of sensors are measured in batches. For example, the drain currents of photo-sensing elements in a same row are measured in a batch (e.g., as a set).

In some embodiments, the drain currents of the photo-sensing elements in the array of sensors are concurrently measured. For example, the drain currents of the photo-sensing elements in a same row are concurrently measured.

In some embodiments, the drain currents of the photo-sensing elements in the array of sensors are sequentially measured. For example, the drain currents of the photo-sensing elements in a same column are concurrently measured.

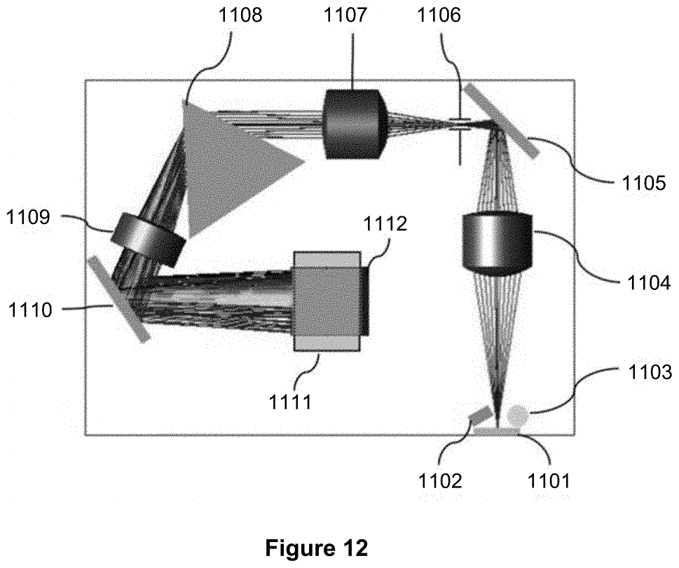

FIG. 12 illustrates spectrometers in accordance with some embodiments.

In FIG. 12, spectrometers include input aperture 1106 for receiving light that includes a visible wavelength component (e.g., light having a visible wavelength, such as 600 nm) and shortwave infrared wavelength component (e.g., light having a shortwave infrared wavelength, such as 1500 nm). In some embodiments, the light received by input aperture 1106 has a continuous spectrum ranging from a visible wavelength to a shortwave infrared wavelength (e.g., light from 600 nm to 1500 nm). In some embodiments, the light received by input aperture 1106 has discrete peaks in one or more visible wavelengths and/or one or more shortwave infrared wavelengths. In some embodiments, input aperture 1106 includes a substrate with a first portion of the substrate coated to block transmission of the light received on the input aperture and a second portion, distinct from the first portion, of the substrate configured to allow transmission of at least a portion of the light received on the input aperture (e.g., the second portion does not overlap with the first portion). In some embodiments, input aperture 1106 includes a glass substrate. In some embodiments, input aperture 1106 includes a sapphire substrate. In some embodiments, input aperture 1106 includes a plastic substrate (e.g., polycarbonate substrate) that is optically transparent to visible and shortwave infrared light. In some embodiments, the coating is located on a surface, of the substrate, facing the incoming light (e.g., light from a sample or a target object). In some embodiments, the coating is located on a surface, of the substrate, facing away from the incoming light. In some embodiments, input aperture 1106 is a linear aperture (e.g., an entrance slit). Input aperture 1106 is configured to transmit both the visible wavelength component and the shortwave infrared wavelength component. For example, input aperture 1106 is transparent to both the visible wavelength component and the shortwave infrared wavelength component (e.g., input aperture 1106 has a transmittance of at least 60% in the visible and shortwave infrared wavelength range). In some embodiments, input aperture 1106 is configured to reduce transmission of light in a particular wavelength range (e.g., input aperture 1106 is configured to reduce transmission of ultraviolet light).

The spectrometers also include first set 1107 of one or more lenses configured to relay light from the input aperture. In some embodiments, first set 1107 of one or more lenses is configured to collimate the light from the input aperture. In some embodiments, first set 1107 of one or more lenses includes a doublet that is configured to reduce one or more aberrations (e.g., chromatic aberration) in visible and shortwave infrared wavelengths. In some embodiments, first set 1107 of one or more lenses includes a triplet or any other combination of multiple lenses (e.g., multiple lenses cemented together or multiple separate lenses). First set 1107 of one or more lenses is configured to transmit both the visible wavelength components and the shortwave infrared wavelength component.

The spectrometers further include one or more dispersive optical elements, such as dispersive optical element 1108 (e.g., a prism), configured to disperse light from first set 1107 of one or more lenses. The light from first set 1107 of one or more lenses includes the visible wavelength component and the shortwave infrared wavelength component. In some embodiments, the one or more dispersive optical elements include one or more transmission dispersive optical elements (e.g., a volume holographic transmission grating). The one or more dispersive optical elements are configured to transmit both the visible wavelength components and the shortwave infrared wavelength component.

In some embodiments, the one or more dispersive optical elements include one or more prisms. Diffraction gratings are configured to disperse light multiple orders, and light of a particular wavelength is dispersed into multiple directions. Thus, two different wavelength components can be dispersed into a same direction (e.g., a second order diffraction of 500 nm light and a first order diffraction of 1000 nm light overlap; and similarly, a third order diffraction of 500 nm light, a second order diffraction of 750 nm light, and a first order diffraction of 1500 nm light overlap). This limits a wavelength range that can be concurrently analyzed by the spectrometer. Prisms do not disperse light of a particular wavelength into multiple directions. Thus, the use of a prism can significantly increase the wavelength range of light that can be concurrently analyzed. In some embodiments, the one or more prisms include one or more equilateral prisms.

The spectrometers include second set 1109 of one or more lenses configured to focus the dispersed light. In some embodiments, second set 1109 of one or more lenses includes a doublet that is configured to reduce one or more aberrations (e.g., chromatic aberration) in visible and shortwave infrared wavelengths. In some embodiments, second set 1109 of one or more lenses includes a triplet or any other combination of multiple lenses (e.g., multiple lenses cemented together or multiple separate lenses). Second set 1109 of one or more lenses is configured to transmit both the visible wavelength components and the shortwave infrared wavelength component. In some embodiments, the light focused by second set 1109 of one or more lenses includes light of a wavelength range from 600 nm to 1500 nm.

The spectrometers include array detector 1112 configured for converting the light from second set 1109 of one or more lenses to electrical signals (e.g., a two-dimensional array of gate-controlled charge modulation devices described herein, such as the image sensor device illustrated in FIG. 10). The electrical signals include electrical signals indicating intensity of the visible wavelength component and electrical signals indicating intensity of the shortwave infrared wavelength component.

In some embodiments, array detector 1112 includes a contiguous detector array that is capable of converting the visible wavelength component and the shortwave infrared wavelength component to electrical signals (e.g., a single detector array generates both electrical signals indicating the intensity of the visible wavelength component and electrical signals indicating the intensity of the shortwave infrared wavelength component).

In some embodiments, the contiguous detector array has a quantum efficiency of at least 20% for light of 1500 nm wavelength. In some embodiments, the contiguous detector array has a quantum efficiency of at least 20% for light of 600 nm wavelength. In some embodiments, the contiguous detector array is a germanium detector array.

In some embodiments, the contiguous detector array includes a two-dimensional array of devices for sensing light (e.g., 100×100 array of devices for sensing light). In some embodiments, each device of the two-dimensional array of devices is a charge modulation device. In some embodiments, each device of the two-dimensional array of devices is a charge modulation device. In some embodiments, the contiguous detector array includes a one-dimensional array of devices for sensing light (e.g., 100×1 array of devices for sensing light).

In some embodiments, array detector 1112 is a two-dimensional array of devices for sensing light. In such embodiments, the spectrometer can be used for hyperspectral imaging.

In FIG. 12, array detector 1112 is positioned parallel to a plane defined by optical paths from input aperture 1106 to second set 1109 of one or more lenses (e.g., a plane that encompasses an optical path from input aperture 1106 to first set 1107 of one or more lenses, an optical path from first set 1107 of one or more lenses to dispersive optical element 1108, an optical path from dispersive optical element 1108 to second set 1109 of one or more lenses). In some embodiments, array detector 1112 is substantially parallel to any of the optical paths from input aperture 1106 to second set 1109 of one or more lenses (e.g., an angle defined by a surface normal of array detector 1112 and a respective optical path is more than, for example, 45 degrees, 60 degrees, or 75 degrees). For example, in some cases, array detector 1112 is laid down flat on a bottom of the spectrometer. This further reduces a size of the spectrometer.

The spectrometers optionally include detection window 1101, one or more light sources (e.g., visible light source 1102 and/or infrared light source 1103) for illuminating a sample, and/or third set 1104 of one or more lenses for focusing light from an object (or a sample) onto the input aperture. For example, third set 1104 of one or more lenses focus diffuse reflection from the object onto the input aperture. Detection window 1101 and third set 1104 of one or more lenses are configured to transmit both the visible wavelength components and the shortwave infrared wavelength component. In some embodiments, the one or more light sources include a broadband light source configured to concurrently emit light that corresponds to the visible wavelength component and light that corresponds to the shortwave infrared wavelength component. In some embodiments, the one or more light sources include one or more visible light sources (e.g., visible light source 1102) configured to emit light that corresponds to the visible wavelength component and one or more shortwave infrared light sources (e.g., shortwave infrared light source 1103) configured to emit light that corresponds to the shortwave infrared wavelength component.

In some embodiments, the spectrometers include one or more mirrors for directing light. In FIG. 12, the spectrometer includes mirror 1110 configured to reflect the light from second set 1109 of one or more lenses toward array detector 1112. In some embodiments, an optical axis of light from mirror 1110 is substantially parallel (e.g., an angle formed by the optical axis of light from mirror 1110 and the optical axis between first set 1107 of one or more lenses and the one or more dispersive optical elements is 30 degrees or less) to an optical axis between first set 1107 of one or more lenses and the one or more dispersive optical elements (e.g., dispersive optical element 1108). In FIG. 12, the spectrometer includes mirror 1110 and mirror 1111 between second set 1109 of one or more lenses and array detector 1112. Mirror 1110 is configured to relay light from second set 1109 of one or more lenses to mirror 1111. In some embodiments, mirror 1111 is configured to reflect the light from mirror 1110 by 90 degrees toward array detector 1112.

In FIG. 12, the spectrometer also includes mirror 1105 for relaying light from third set 1104 of one or more lenses toward input aperture 1106.

The size of the entire spectrometer illustrated in FIG. 12, including detector array 1112, is 4.3 cm in length by 3.3 cm in width by 0.7 cm in height, or smaller.

In some embodiments, the spectrometer includes one or more mirrors configured to reflect the light from the first set of one or more lenses toward the one or more dispersive optical elements so that the light from the second set of one or more lenses is substantially parallel to the light from the first set of one or more lenses (e.g., an optical axis of the first set of one or more lenses and an optical axis of the second set of one or more lenses form an angle that is less than 30 degrees, 20 degrees, 15 degrees, 10 degrees, or 5 degrees). In some embodiments, the spectrometer includes at least two mirrors configured to reflect the light from the first set of one or more lenses toward the one or more dispersive optical elements so that the light from the second set of one or more lenses is substantially parallel to the light from the first set of one or more lenses.

In accordance with some embodiments, a method for concurrently analyzing visible and shortwave infrared light includes receiving light that includes a visible wavelength component and a shortwave infrared wavelength component with any embodiment of the apparatus described above so that at least a portion of the visible wavelength component and at least a portion of the shortwave infrared wavelength component concurrently impinge on the array detector of the apparatus; and processing the electrical signals from the array detector to obtain the intensity of the visible wavelength component and the intensity of the shortwave infrared wavelength component.

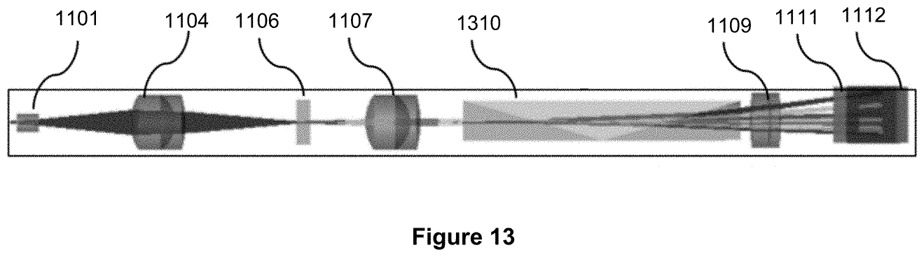

FIG. 13 illustrates a spectrometer in accordance with some embodiments.

The spectrometer shown in FIG. 13 is similar to the spectrometer shown in FIG. 12E except that prism assembly 1310 is used in place of a combination of mirrors 1113 and 1114 and dispersive optical element 1108. Inventors of this application have discovered that a rotation of optical elements, such as one or more mirrors (e.g., mirror 1113 or 1114), contributes to misalignment of the spectrometer. The inventors of this application reduced misalignment of the spectrometer caused by the rotation of one or more mirrors 1113 and 1114 (relative to dispersive optical element 1108) by replacing the combination of mirrors 1113 and 1114 and dispersive optical element 1108 with prism assembly 1310. In addition, the spectrometer shown in FIG. 13 is compact, which improves portability of the spectrometer.

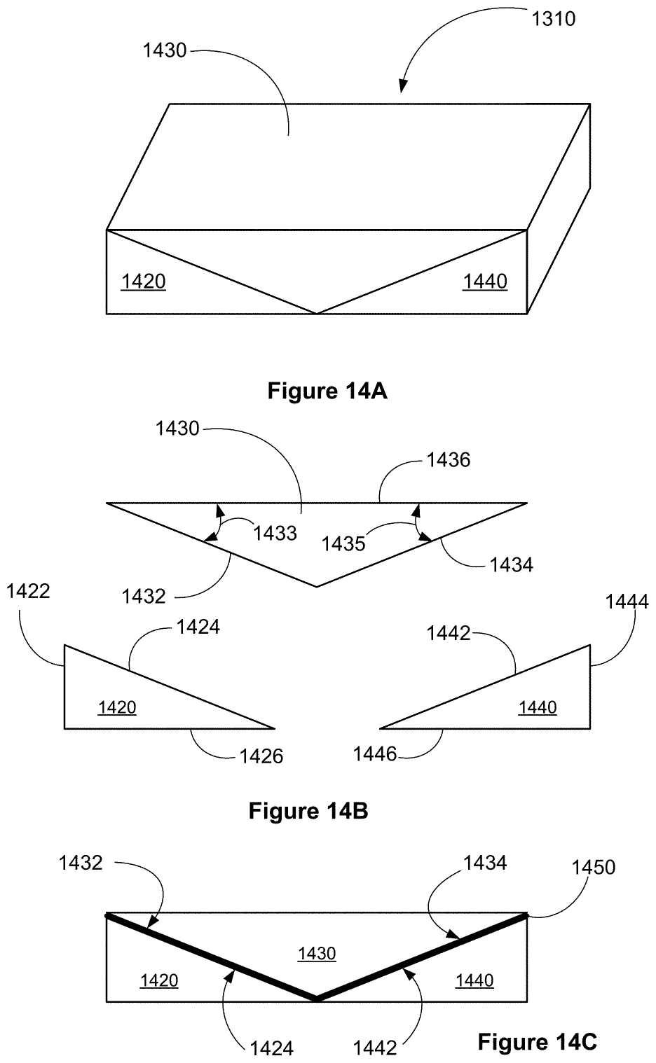

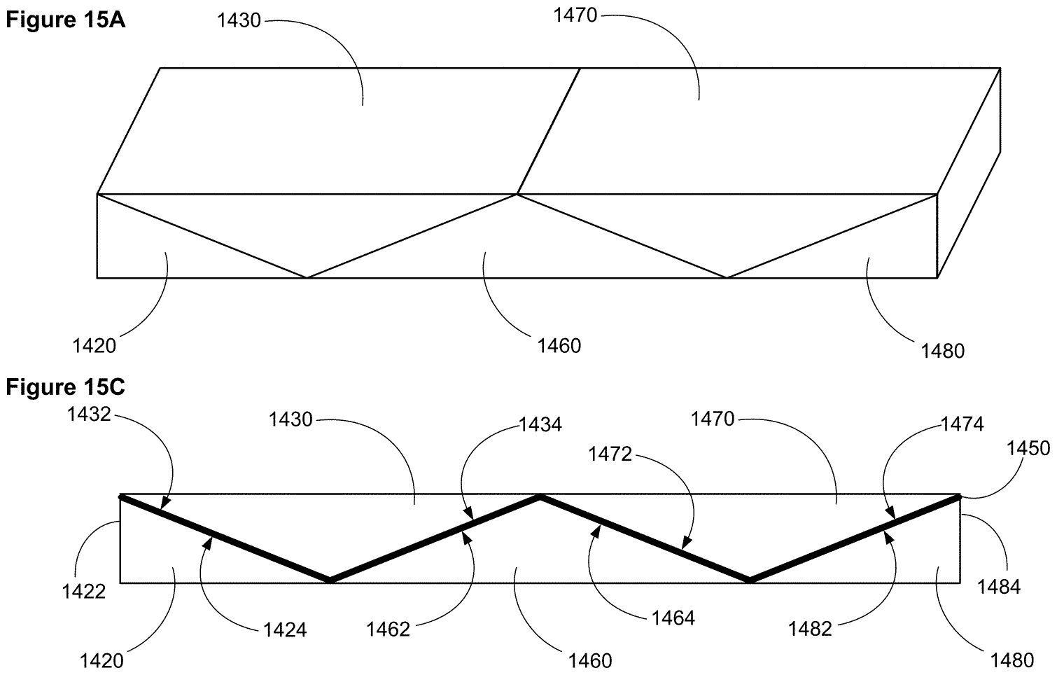

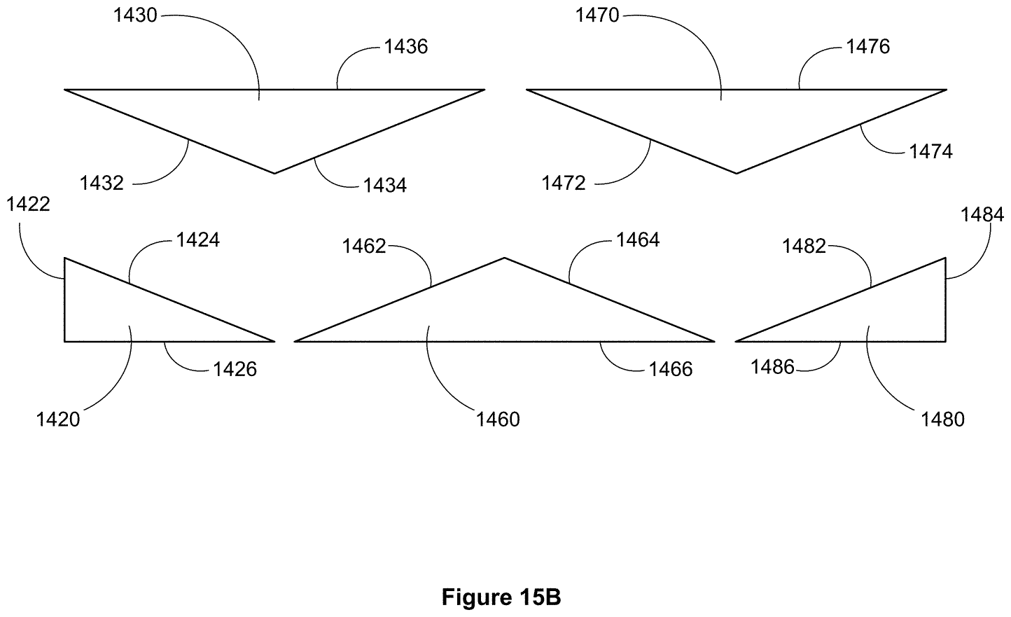

Thus, the spectrometer (e.g., an apparatus for analyzing light) shown in FIG. 13 includes input aperture 1106 for receiving light; first set 1107 of one or more lenses configured to relay light from the input aperture; and prism assembly 1310 configured to disperse light from the first set of one or more lenses. The prism assembly includes a plurality of prisms that includes a first prism, a second prism that is distinct from the first prism, and a third prism that is distinct from the first prism and the second prism (e.g., prism assembly 1310 shown in FIG. 14A with three prisms or the prism assembly shown in FIG. 15A with five prisms). The first prism is mechanically coupled with the second prism and the second prism is mechanically coupled with the third prism. The spectrometer also includes second set 1109 of one or more lenses configured to focus the dispersed light from the prism assembly; and array detector 1112 configured for converting the light from the second set of one or more lenses to electrical signals.

In some embodiments, the spectrometer shown in FIG. 13 has one or more characteristics and features of the spectrometers described with respect to FIG. 12. For brevity, such details are not repeated herein.

In some embodiments, prism assembly 1310 and second set 1109 of one or more lenses are positioned so that the light from prism assembly 1310 passes through second set 1109 of one or more lenses without being reflected by any mirror (e.g., FIG. 13).

In some embodiments, second set 1109 of one or more lenses and the array detector are positioned so that the light from second set 1109 of one or more lenses is directed to array detector 1112 without being reflected by any mirror.

In some embodiments, second set 1109 of one or more lenses and the array detector are positioned so that the light from second set 1109 of one or more lenses is directed to array detector 1112 after being reflected by only one mirror (e.g., mirror 1111 in FIG. 13).

In some embodiments, an optical axis of first set 1107 of one or more lenses is parallel to an optical axis of second set 1109 of one or more lenses. In some embodiments, the optical axis of first set 1107 of one or more lenses is parallel to an optical axis of prism assembly 1310. In some embodiments, the optical axis of second set 1109 of one or more lenses is parallel to an optical axis of prism assembly 1310. This allows a compact spectrometer.

In some embodiments, the optical axis of first set 1107 of one or more lenses is perpendicular to an entrance surface of prism assembly 1310.

In some embodiments, the optical axis of second set 1109 of one or more lenses is perpendicular to an exit surface of prism assembly 1310.

FIGS. 14A-14C illustrate prism assembly 1310 and its components in accordance with some embodiments.

Prism assembly 1310 shown in FIG. 14A includes three prisms: first prism 1420, second prism 1430, and third prism 1440. In some embodiments, first prism 1420 is mechanically coupled to second prism 1430 and second prism 1430 is mechanically coupled to third prism 1440 (e.g., using adhesives). This reduces or eliminates rotation of first prism 1420 relative to second prism 1430 and third prism 1440, and reduces or eliminates rotation of second prism 1430 relative to third prism 1440. In addition, the rotation of the entrance surface of prism assembly 1310 is compensated by the rotation of the exit surface of prism assembly 1310. For example, any variation in the direction of refracted light caused by the rotation of the entrance surface of prism assembly 1310 is reduced by the rotation of the exit surface of prism assembly 1310. Thus, misalignment in the spectrometer is reduced by using prism assembly 1310.

In some embodiments, first prism 1420 is a right triangular prism, second prism 1430 is a triangular prism, and third prism 1440 is a right triangular prism.

In some embodiments, first prism 1420 is optically coupled with second prism 1430 and second prism 1430 is optically coupled with third prism 1440. For example, light transmitted from first prism 1420 enters second prism 1430, and light transmitted from second prism 1430 enters third prism 1440.

FIG. 14B is an exploded side view of prism assembly 1310 shown in FIG. 14A. First prism 1420 has first optical surface 1422 and second optical surface 1424. In some embodiments, first prism 1420 has third surface 1426. In some embodiments, third surface 1426 is an optical surface (e.g., a third optical surface). For example, third surface 1426 satisfies optical flatness and surface roughness requirements (e.g., λ/20 flatness and 20-10 scratch-dig). In some embodiments, third surface 1426 is a non-optical surface (e.g., third surface 1426 does not satisfy optical flatness or surface roughness requirements). Second prism 1430 has first optical surface 1432 and second optical surface 1434. In some embodiments, second prism 1430 has third surface 1436. In some embodiments, third surface 1436 is an optical surface (e.g., a third optical surface). In some embodiments, third surface 1436 is a non-optical surface. Third prism 1440 has first optical surface 1442 and second optical surface 1444. In some embodiments, third prism 1440 has third surface 1446. In some embodiments, third surface 1446 is an optical surface (e.g., a third optical surface). In some embodiments, third surface 1446 is a non-optical surface. For second prism 1430, first optical surface 1432 and third surface 1436 define first angle 1433 and second optical surface 1434 and third surface 1436 define second angle 1435.

In some embodiments, first angle 1433 is between 10° and 30°. In some embodiments, first angle 1433 is between 15° and 25°. In some embodiments, first angle 1433 is between 18° and 22°. In some embodiments, first angle 1433 is between 10° and 20°. In some embodiments, first angle 1433 is between 13° and 17°.

In some embodiments, second angle 1435 is between 10° and 30°. In some embodiments, second angle 1435 is between 15° and 25°. In some embodiments, second angle 1435 is between 18° and 22°. In some embodiments, second angle 1435 is between 10° and 20°. In some embodiments, second angle 1435 is between 13° and 17°.

In some embodiments, first angle 1433 and second angle 1435 are identical. In some embodiments, first angle 1433 is distinct from second angle 1435.

First prism 1420 has first optical surface 1422 and second optical surface 1424 that is distinct from, and non-parallel to, first optical surface 1422. Second prism 1430 has first optical surface 1432 and second optical surface 1434 that is distinct from, and non-parallel to, first optical surface 1432. Third prism 1440 has first optical surface 1442 and second optical surface 1444 that is distinct from, and non-parallel to, first optical surface 1442. In some embodiments, second optical surface 1424 of first prism 1420 is optically coupled with first optical surface 1432 of second prism 1430 (e.g., light transmitted from second optical surface 1424 of first prism 1420 enters through first optical surface 1432 of second prism 1430). Second optical surface 1434 of second prism 1430 is optically coupled with first optical surface 1442 of third prism 1440 (e.g., light transmitted from second optical surface 1434 of second prism 1430 enters through first optical surface 1442 of third prism 1440).

In some embodiments, second optical surface 1424 of first prism 1420 is substantially parallel (e.g., having an angle of 20° or less, 15° or less, or 10° or less) to first optical surface 1432 of second prism 1430. In some embodiments, second optical surface 1434 of second prism 1430 is substantially parallel (e.g., having an angle of 20° or less, 15° or less, or 10° or less) to first optical surface 1442 of third prism 1440.

In some embodiments, first prism 1420 has third surface 1426 that is distinct from, and non-parallel to, first optical surface 1422 and second optical surface 1424, and third prism 1440 has third surface 1446 that is distinct from, and non-parallel to, first optical surface 1442 and second optical surface 1444. Third surface 1426 of first prism 1420 is substantially perpendicular (e.g., having an angle between 80° and 100°) to first optical surface 1422 of first prism 1420 (e.g., first prism 1420 is a Littrow prism). Third surface 1446 of third prism 1440 is substantially perpendicular (e.g., having an angle between 80° and 100°) to second optical surface 1444 of third prism 1440 (e.g., third prism 1440 is a Littrow prism).

In some embodiments, second prism 1430 has third surface 1436 that is distinct from, and non-parallel to, first optical surface 1432 of second prism 1430 and second optical surface 1434 of second prism 1430.

In some embodiments, third surface 1436 of second prism 1430 is substantially parallel to third surface 1426 of first prism 1420 and third surface 1446 of third prism 1440.

In some embodiments, first optical surface 1432 of second prism 1430 and third optical surface 1436 of second prism 1430 define a first angle, and second optical surface 1434 of second prism 1430 and third optical surface 1436 of second prism 1430 define a second angle. The second angle corresponds to the first angle (e.g., the second angle and the first angle are the same). For example, second prism 1430 has a cross section that has a shape of an equilateral triangle.

In some embodiments, first optical surface 1422 of first prism 1420 is substantially parallel (e.g., having an angle of 20° or less, 15° or less, or 10° or less) to second optical surface 1444 of third prism 1440. In some embodiments, prism assembly 1310 has a shape of a rectangular prism.

In some embodiments, first prism 1420 and third prism 1440 have a same shape (e.g., both first prism 1420 and third prism 1440 have same dimensions).

In some embodiments, first prism 1420 is a Littrow prism, second prism 1430 is a triangular component prism, and third prism 1440 is a Littrow prism.

In some embodiments, the second prism is an equilateral prism (e.g., an equilateral triangular prism).

Although FIG. 14B illustrates that the prism assembly is made by combining three distinct and separate prisms, in some embodiments, the first prism and the third prism are integrally formed.

FIG. 14C illustrates that first prism 1420 and second prism 1430 are mechanically coupled by adhesive 1450 and second prism 1430 and third prism 1440 are mechanically coupled by adhesive 1450.

FIGS. 15A-15C illustrate a prism assembly and its components in accordance with some embodiments.

The prism assembly shown in FIG. 15A is similar to prism assembly shown in FIG. 14A, except that the prism assembly shown in FIG. 15A includes five prisms: first prism 1420, second prism 1430, third prism 1460, fourth prism 1470, and fifth prism 1480. For example, the prism assembly includes, in addition to first prism 1420, second prism 1430, and third prism 1460, (i) fourth prism 1470 that is distinct from first prism 1420, second prism 1430, and third prism 1460 and (ii) fifth prism 1480 that is distinct from first prism 1420, second prism 1430, third prism 1460, and fourth prism 1470.

In some embodiments, first prism 1420 is mechanically coupled to second prism 1430, second prism 1430 is mechanically coupled to third prism 1460, third prism 1460 is mechanically coupled to fourth prism 1470, and fourth prism 1470 is mechanically coupled with fifth prism 1480. This reduces or eliminates rotation of first prism 1420 relative to second prism 1430, third prism 1460, fourth prism 1470, and fifth prism 1480; reduces or eliminates rotation of second prism 1430 relative to third prism 1460, fourth prism 1470, and fifth prism 1480; reduces or eliminates rotation of third prism 1460 relative to fourth prism 1470 and fifth prism 1480; and reduces or eliminates rotation of fourth prism 1470 relative to fifth prism 1480. In some embodiments, first prism 1420 is a right triangular prism, second prism 1430 is a triangular prism (other than a right triangular prism), third prism 1460 is a triangular prism (other than a right triangular prism), fourth prism 1470 is a triangular prism (other than a right triangular prism), and fifth prism 1480 is a right triangular prism.

In some embodiments, first prism 1420 is optically coupled with second prism 1430, second prism 1430 is optically coupled with third prism 1460, third prism 1460 is optically coupled with fourth prism 1470, and fourth prism 1470 is optically coupled with fifth prism 1480. For example, light transmitted from first prism 1420 enters second prism 1430, light transmitted from second prism 1430 enters third prism 1460, light transmitted from third prism 1460 enters fourth prism 1470, and light transmitted from fourth prism 1470 enters fifth prism 1480. Light dispersed by the prism assembly is transmitted from fifth prism 1480.

FIG. 15B is an exploded side view of the prism assembly shown in FIG. 15A. First prism 1420 has first optical surface 1422 and second optical surface 1424 that is distinct from, and non-parallel to, first optical surface 1422. In some embodiments, first prism 1420 also has third surface 1426 that is distinct from, and non-parallel to, first optical surface 1422 and second optical surface 1424. Second prism 1430 has first optical surface 1432 and second optical surface 1434 that is distinct from, and non-parallel to, first optical surface 1432. In some embodiments, second prism 1430 also has third surface 1436 that is distinct from, and non-parallel to, first optical surface 1432 and second optical surface 1434. Third prism 1460 has first optical surface 1462 and second optical surface 1464 that is distinct from, and non-parallel to, first optical surface 1462. In some embodiments, third prism 1460 also has third surface 1466 that is distinct from, and non-parallel to, first optical surface 1462 and second optical surface 1464. Fourth prism 1470 has first optical surface 1472, second optical surface 1474 that is distinct from, and non-parallel to, first optical surface 1472, and third surface 1476 that is distinct from, and non-parallel to, first optical surface 1472 and second optical surface 1474. Fifth prism 1480 has first optical surface 1482, second optical surface 1484 that is distinct from, and non-parallel to, first optical surface 1482, and third surface 1486 that is distinct from first optical surface 1482 and second optical surface 1484.

In some embodiments, second optical surface 1424 of first prism 1420 is optically coupled with first optical surface 1432 of second prism 1430 (e.g., light transmitted from second optical surface 1424 of first prism 1420 enters through first optical surface 1432 of second prism 1430). In some embodiments, second optical surface 1434 of second prism 1430 is optically coupled with first optical surface 1462 of third prism 1460 (e.g., light transmitted from second optical surface 1434 of second prism 1430 enters through first optical surface 1462 of third prism 1460). In some embodiments, second optical surface 1464 of third prism 1460 is optically coupled with first optical surface 1472 of fourth prism 1470 (e.g., light transmitted from second optical surface 1464 of third prism 1460 enters through first optical surface 1472 of fourth prism 1470). In some embodiments, second optical surface 1474 of fourth prism 1470 is optically coupled with first optical surface 1482 of fifth prism 1480 (e.g., light transmitted from second optical surface 1474 of fourth prism 1470 enters through first optical surface 1482 of fifth prism 1480).

In some embodiments, first prism 1420 has third surface 1426 that is distinct from, and non-parallel to, first optical surface 1422 and second optical surface 1424. In some embodiments, fifth prism 1480 has third surface 1486 that is distinct from, and non-parallel to first optical surface 1482 and second optical surface 1484. In some embodiments, third surface 1426 of first prism 1420 is substantially perpendicular (e.g., having an angle between 80° and) 100° to first optical surface 1422 of first prism 1420 (e.g., first prism 1420 is a Littrow prism). In some embodiments, third surface 1486 of fifth prism 1480 is substantially perpendicular (e.g., having an angle between 80° and 100°) to second optical surface 1484 of fifth prism 1480 (e.g., fifth prism 1480 is a Littrow prism).

In some embodiments, second prism 1430 has third surface 1436 that is distinct from, and non-parallel to, first optical surface 1432 and second optical surface 1434. In some embodiments, third prism 1460 has third surface 1466 that is distinct from, and non-parallel to, first optical surface 1462 and second optical surface 1464. In some embodiments, fourth prism 1470 has third surface 1476 that is distinct from, and non-parallel to, first optical surface 1472 and second optical surface 1474. In some embodiments, third surface 1426 of first prism 1420 is substantially parallel (e.g., having an angle of 20° or less, 15° or less, or 10° or less) to third surface 1436 of second prism 1430, third surface 1466 of third prism 1460, third surface 1476 of fourth prism 1470, and third surface 1486 of fifth prism 1480.

In some embodiments, an angle defined by first optical surface 1432 of second prism 1430 and third surface 1436 of second prism 1430 corresponds to an angle defined by second optical surface 1434 of second prism 1430 and third surface 1436 of second prism 1430 (e.g., second prism 1430 has a cross-section having a shape of an equilateral triangle). In some embodiments, an angle defined by first optical surface 1462 of third prism 1460 and third surface 1466 of third prism 1460 corresponds to an angle defined by second optical surface 1464 of third prism 1460 and third surface 1466 of third prism 1460 (e.g., third prism 1460 has a cross-section having a shape of an equilateral triangle). In some embodiments, an angle defined by first optical surface 1472 of fourth prism 1470 and third surface 1476 of fourth prism 1470 corresponds to an angle defined by second optical surface 1474 of fourth prism 1470 and third surface 1476 of fourth prism 1470 (e.g., fourth prism 1470 has a cross-section having a shape of an equilateral triangle).

In some embodiments, the angle defined by first optical surface 1432 of second prism 1430 and third surface 1436 of second prism 1430 corresponds to the angle defined by first optical surface 1462 of third prism 1460 and third surface 1466 of third prism 1460. In some embodiments, the angle defined by first optical surface 1432 of second prism 1430 and third surface 1436 of second prism 1430 corresponds to the angle defined by first optical surface 1472 of fourth prism 1470 and third surface 1476 of fourth prism 1470.

In some embodiments, first optical surface 1422 of first prism 1420 is substantially parallel to second optical surface 1484 of fifth prism 1480 (e.g., first optical surface 1422 of first prism 1420 and second optical surface 1484 of fifth prism 1480 have an angle of 20° or less, 15° or less, or 10° or less). In some embodiments, the prism assembly has a shape of a rectangular prism.

In some embodiments, first prism 1420 and fifth prism 1480 have a same shape (e.g., both first prism 1420 and fifth prism 1480 have same dimensions).

In some embodiments, first prism 1420 is a Littrow prism, second prism 1430 is a triangular component prism, third prism 1460 is a triangular component prism, fourth prism 1470 is a triangular component prism, and fifth prism 1480 is a Littrow prism.

In some embodiments, second prism 1430 is an equilateral prism (e.g., an equilateral triangular prism), third prism 1460 is an equilateral prism (e.g., an equilateral triangular prism); and fourth prism 1470 is an equilateral prism (e.g., an equilateral triangular prism).

Although FIG. 15B illustrates that the prism assembly is made by combining five distinct and separate prisms, in some embodiments, one or more prisms are integrally formed. For example, in some embodiments, the first prism, the third prism, and the fifth prism are integrally formed, and/or the second prism and the fourth prism are integrally formed.

FIG. 15C illustrates that first prism 1420 and second prism 1430 are mechanically coupled by adhesive 1450, second prism 1430 and third prism 1460 are mechanically coupled by adhesive 1450, third prism 1460 and fourth prism 1470 are mechanically coupled by adhesive 1450, and fourth prism 1470 and fifth prism 1480 are mechanically coupled by adhesive 1450.

In some embodiments, the prism assembly has an entrance surface (e.g., the first optical surface of the first prism, such as optical surface 1422 of first prism 1420) through which the prism assembly is configured to receive the light from the first set of one or more lenses. The prism assembly has an exit surface (e.g., the second optical of the last prism, such as optical surface 1444 of third prism 1440, in case of prism assembly 1310) through which the prism assembly is configured to transmit the dispersed light toward the second set of one or more lenses. The entrance surface of the prism assembly is substantially parallel (e.g., having an angle of 20° or less, 15° or less, or 10° or less) to the exit surface of the prism assembly. This facilitates maintaining an optical axis before and after the prism assembly, which in turn allows a linear configuration of the spectrometer. In some embodiments, the prism assembly has a shape of a rectangular prism.

In some embodiments, each prism of the prism assembly is configured to disperse light of a wavelength range from 600 nm to 1500 nm. For example, each prism of the prism assembly is configured to disperse light having a wavelength of 600 nm from light having a wavelength of 1500 nm. In some embodiments, each prism of the prism assembly is configured to disperse light having a wavelength of 600 nm and light having a wavelength of 1500 nm.

In some embodiments, the first prism is made of a first material; the second prism is made of a second material that is distinct from the first material; and the first material has a first Abbe number and the second material has a second Abbe number that is less than the first Abbe number (e.g., the first prism is made of a material having an Abbe number of 50 and the second prism is made of a material having an Abbe number of 30).

In some embodiments, the third prism is made of a third material; the second prism is made of a second material that is distinct from the third material; and the third material has a third Abbe number and the second material has a second Abbe number that is less than the third Abbe number (e.g., the third prism is made of a material having an Abbe number of 50 and the second prism is made of a material having an Abbe number of 30).

In some embodiments, the first prism is made of a first material; the second prism is made of a second material that is distinct from the first material; and the third prism is made of a third material that is distinct from the second material. The first material has a first Abbe number; the third material has a third Abbe number; and the second material has a second Abbe number that is less than the first Abbe number and the third Abbe number (e.g., the first prism is made of a material having an Abbe number of 50, the second prism is made of a material having an Abbe number of 30, and the third prism is made of a material having an Abbe number of 40).

In some embodiments, the first material and the third material are identical (e.g., the first prism is made of a material having an Abbe number of 50, the second prism is made of a material having an Abbe number of 30, and the third prism is made of a material having an Abbe number of 50).

In some embodiments, when the prism assembly includes five prisms, the first prism is made of the first material, the second prism is made of the second material, the third prism is made of the second material, the fourth prism is made of the second material, and the fifth prism is made of the first material.

In some embodiments, when the prism assembly includes five prisms, the first prism is made of the first material, the second prism is made of the second material, the third prism is made of the first material, the fourth prism is made of the second material, and the fifth prism is made of the first material.

In some embodiments, the first material is selected from fluorite crown, phosphate crown, dense phosphate crown, borosilicate crown, barium crown, dense crown, crown, lanthanum crown, very dense crown, barium light flint, crown/flint, lanthanum dense flint, lanthanum flint, barium flint, barium dense flint, very light flint, light flint, flint, dense flint, zinc crown, short flint.

In some embodiments, the second material is selected from fluorite crown, phosphate crown, dense phosphate crown, borosilicate crown, barium crown, dense crown, crown, lanthanum crown, very dense crown, barium light flint, crown/flint, lanthanum dense flint, lanthanum flint, barium flint, barium dense flint, very light flint, light flint, flint, dense flint, zinc crown, short flint.

In some embodiments, the third material is selected from fluorite crown, phosphate crown, dense phosphate crown, borosilicate crown, barium crown, dense crown, crown, lanthanum crown, very dense crown, barium light flint, crown/flint, lanthanum dense flint, lanthanum flint, barium flint, barium dense flint, very light flint, light flint, flint, dense flint, zinc crown, short flint.

In some embodiments, the first Abbe number is greater than 30; the second Abbe number is less than 50; and the third Abbe number is greater than 30.

In some embodiments, the first Abbe number is greater than 40; the second Abbe number is less than 40; and the third Abbe number is greater than 40.

In some embodiments, the first Abbe number is greater than 35. In some embodiments, the first Abbe number is greater than 40. In some embodiments, the first Abbe number is greater than 45. In some embodiments, the first Abbe number is greater than 50. In some embodiments, the first Abbe number is greater than 55. In some embodiments, the first Abbe number is greater than 60. In some embodiments, the first Abbe number is greater than 65. In some embodiments, the first Abbe number is greater than 70. In some embodiments, the first Abbe number is greater than 75. In some embodiments, the first Abbe number is greater than 80.

In some embodiments, the first Abbe number is less than 40. In some embodiments, the first Abbe number is less than 45. In some embodiments, the first Abbe number is less than 50. In some embodiments, the first Abbe number is less than 55. In some embodiments, the first Abbe number is less than 60. In some embodiments, the first Abbe number is less than 65. In some embodiments, the first Abbe number is less than 70. In some embodiments, the first Abbe number is less than 75. In some embodiments, the first Abbe number is less than 80. In some embodiments, the first Abbe number is less than 85.

In some embodiments, the first Abbe number is between 20 and 70. In some embodiments, the first Abbe number is between 35 and 85. In some embodiments, the first Abbe number is between 45 and 75. In some embodiments, the first Abbe number is between 55 and 65. In some embodiments, the first Abbe number is between 30 and 80. In some embodiments, the first Abbe number is between 40 and 70. In some embodiments, the first Abbe number is between 50 and 60. In some embodiments, the first Abbe number is between 45 and 90. In some embodiments, the first Abbe number is between 55 and 85. In some embodiments, the first Abbe number is between 65 and 75.

In some embodiments, the second Abbe number is less than 45. In some embodiments, the second Abbe number is less than 40. In some embodiments, the second Abbe number is less than 35. In some embodiments, the second Abbe number is less than 30. In some embodiments, the second Abbe number is less than 25.

In some embodiments, the second Abbe number is greater than 45. In some embodiments, the second Abbe number is greater than 40. In some embodiments, the second Abbe number is greater than 35. In some embodiments, the second Abbe number is greater than 30. In some embodiments, the second Abbe number is greater than 25. In some embodiments, the second Abbe number is greater than 20.

In some embodiments, the first Abbe number is between 20 and 70. In some embodiments, the second Abbe number is between 35 and 85. In some embodiments, the second Abbe number is between 45 and 75. In some embodiments, the second Abbe number is between 55 and 65. In some embodiments, the second Abbe number is between 30 and 80. In some embodiments, the second Abbe number is between 40 and 70. In some embodiments, the second Abbe number is between 50 and 60. In some embodiments, the second Abbe number is between 45 and 90. In some embodiments, the second Abbe number is between 55 and 85. In some embodiments, the second Abbe number is between 65 and 75.

In some embodiments, the third Abbe number is greater than 35. In some embodiments, the third Abbe number is greater than 40. In some embodiments, the third Abbe number is greater than 45. In some embodiments, the third Abbe number is greater than 50. In some embodiments, the third Abbe number is greater than 55. In some embodiments, the third Abbe number is greater than 60. In some embodiments, the third Abbe number is greater than 65. In some embodiments, the third Abbe number is greater than 70. In some embodiments, the third Abbe number is greater than 75. In some embodiments, the third Abbe number is greater than 80.

In some embodiments, the third Abbe number is less than 40. In some embodiments, the third Abbe number is less than 45. In some embodiments, the third Abbe number is less than 50. In some embodiments, the third Abbe number is less than 55. In some embodiments, the third Abbe number is less than 60. In some embodiments, the third Abbe number is less than 65. In some embodiments, the third Abbe number is less than 70. In some embodiments, the third Abbe number is less than 75. In some embodiments, the third Abbe number is less than 80. In some embodiments, the third Abbe number is less than 85.

In some embodiments, the third Abbe number is between 20 and 70. In some embodiments, the third Abbe number is between 35 and 85. In some embodiments, the third Abbe number is between 45 and 75. In some embodiments, the third Abbe number is between 55 and 65. In some embodiments, the third Abbe number is between 30 and 80. In some embodiments, the third Abbe number is between 40 and 70. In some embodiments, the third Abbe number is between 50 and 60. In some embodiments, the third Abbe number is between 45 and 90. In some embodiments, the third Abbe number is between 55 and 85. In some embodiments, the third Abbe number is between 65 and 75.

In some embodiments, the first Abbe number is between 40 and 70, the second Abbe number is between 20 and 40, and the third Abbe number is between 40 and 70.

In some embodiments, each prism of the prism assembly has a refractive index that is within 20% of a reference refractive index. For example, when the reference refractive index is 1.5, each prism of the prism assembly has a refractive index that is between 1.2 and 1.8). In some embodiments, each prism of the prism assembly has a refractive index that is within 15% of a reference refractive index. In some embodiments, each prism of the prism assembly has a refractive index that is within 10% of a reference refractive index. In some embodiments, each prism of the prism assembly has a refractive index that is within 5% of a reference refractive index. In some embodiments, each prism of the prism assembly has a refractive index that is within 3% of a reference refractive index. In some embodiments, each prism of the prism assembly has a refractive index that is within 1% of a reference refractive index.

In some embodiments, the reference refractive index is between 1.5 and 1.9. In some embodiments, the reference refractive index is between 1.6 and 1.8. In some embodiments, the reference refractive index is between 1.65 and 1.75. In some embodiments, the reference refractive index is between 1.6 and 1.9. In some embodiments, the reference refractive index is between 1.7 and 1.8. In some embodiments, the reference refractive index is between 1.5 and 1.8. In some embodiments, the reference refractive index is between 1.6 and 1.7.

In some embodiments, each prism of the prism assembly is coupled with one or more prisms of the prism assembly using an adhesive that has a refractive index that is within 20% of the reference refractive index. For example, as shown in FIGS. 14C and 15C, the prisms are attached to one another by adhesive 1450. When the reference refractive index is 1.5, the adhesive has a refractive index that is between 1.2 and 1.8. In some embodiments, each prism of the prism assembly is coupled with one or more prisms of the prism assembly using an adhesive that has a refractive index that is within 15% of the reference refractive index. In some embodiments, each prism of the prism assembly is coupled with one or more prisms of the prism assembly using an adhesive that has a refractive index that is within 10% of the reference refractive index. In some embodiments, each prism of the prism assembly is coupled with one or more prisms of the prism assembly using an adhesive that has a refractive index that is within 5% of the reference refractive index. In some embodiments, each prism of the prism assembly is coupled with one or more prisms of the prism assembly using an adhesive that has a refractive index that is within 3% of the reference refractive index. In some embodiments, each prism of the prism assembly is coupled with one or more prisms of the prism assembly using an adhesive that has a refractive index that is within 1% of the reference refractive index.

The spectrometer with the prism assembly can better maintain its alignment even when the prism assembly is rotated. Thus, the spectrometer with the prism assembly is less sensitive to any variation in the angular position of the prism assembly, such spectrometer can be manufactured more easily. In addition, such spectrometer is more robust to any changes in the angular position of the prism assembly, which in turn allows the spectrometer to maintain its calibration. This is especially useful for field applications, where the spectrometer can be subject to mechanical shocks, vibrations, and temperature changes, which can change the angular position of the prism assembly.

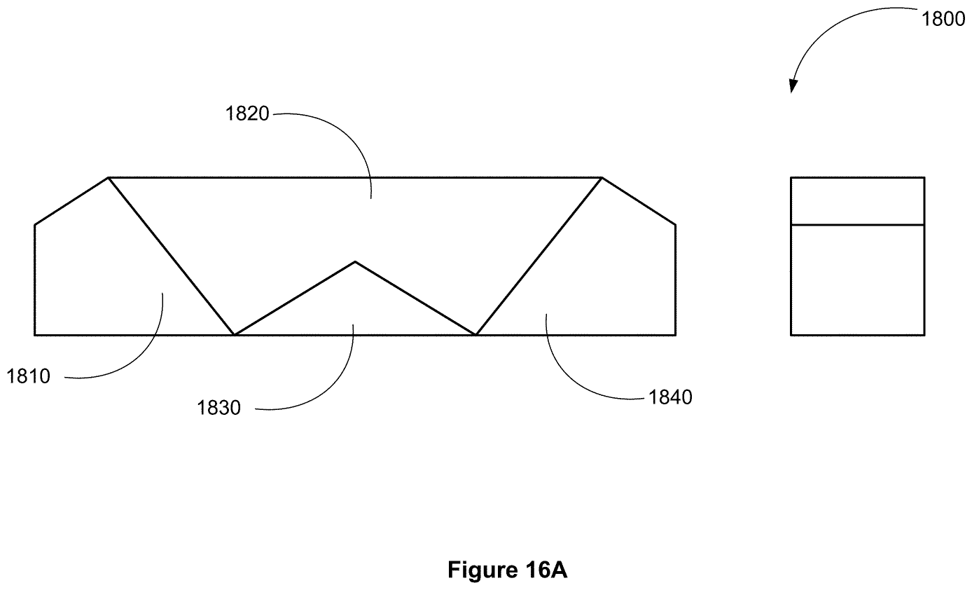

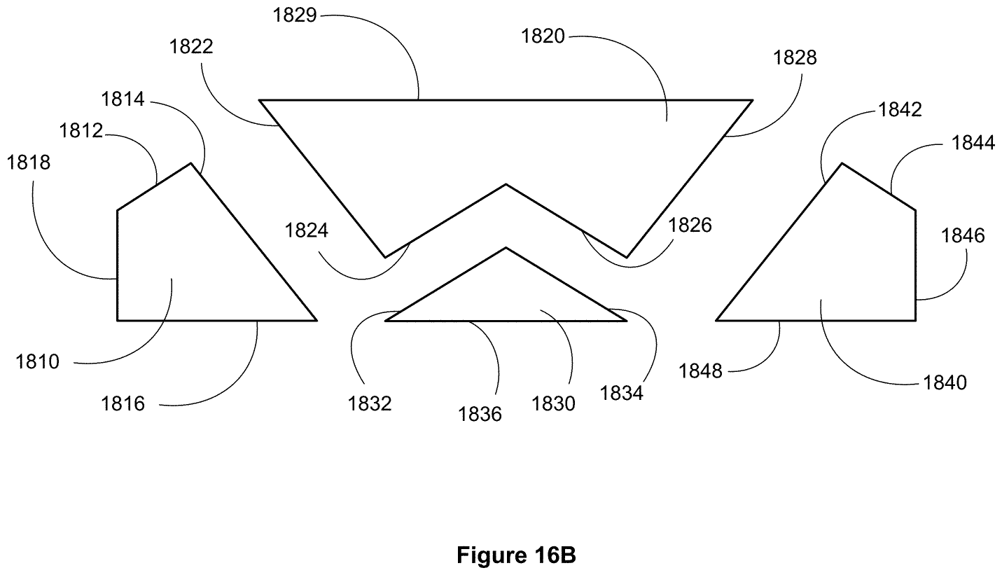

FIGS. 16A and 16B illustrate prism assembly 1800 and its components in accordance with some embodiments. The front view and the side view of prism assembly 1800 are shown in FIG. 16A. The front view of prism assembly 1800 shows four prisms 1810, 1820, 1830, and 1840, and the side view of prism assembly 1800 shows a side view of prism 1840.

Prism assembly 1800 includes a set of one or more prisms (e.g., set 1820 of one or more prisms), first prism (e.g., prism 1810) that is distinct from the set of one or more prisms and is mechanically coupled with the set of one or more prisms, second prism (e.g., prism 1830) that is distinct from the set of one or more prisms and the first prism and is mechanically coupled with the set of one or more prisms, and third prism (e.g., prism 1840) that is distinct from the set of one or more prisms, the first prism, and the second prism and is mechanically coupled with the set of one or more prisms.

The optical axis of prism assembly 1800 extends along a length of prism assembly 1800. In some embodiments, the optical axis of prism assembly 1800 is parallel to a bottom surface of prism assembly 1800 (which, in some cases, include the bottom surface of prism 1810, the bottom surface of prism 1830, and the bottom surface of prism 1840 as shown in FIG. 16A).

In some embodiments, the third prism is separate from the first prism. In some embodiments, the second prism is separate from the first prism. In some embodiments, the second prism is separate from the third prism.

In some embodiments, the prism assembly is characterized by at least one of the following: the second prism is separate from the first prism; and the third prism is separate from the second prism. For example, in some cases, the second prism is separate from the first prism, but the third prism is not separate from the second prism (e.g., the third prism and the second prism are integrated). In some cases, the second prism is not separate from the first prism (e.g., the first prism and the second prism are integrated), but the third prism is separate from the second prism. In some cases, the second prism is separate from the first prism, and the third prism is separate from the second prism.

In some embodiments, the first prism is made of a first material. In some embodiments, the first material selected from a group consisting of: FCD1, N-PK52A, S-FPL51, J-FK01, H-FK61, FCD10A, H-FK71, FCD100, S-FPL53, FCD515, S-FPM2, J-PSKH1, H-ZPK5, FCD600, FCD705, PCD4, N-PSK53A, S-PHM52, J-PSK02, H-ZPK1A, PCD40, PCD51, S-FPM2, J-PSKH4, H-ZPK3, LAC8, N-LAK8, S-LAL, J-LAK8, H-LaK7A, LAC14, N-LAK14, S-LAL14, J-LAK14, H-LaK51A, TAC8, N-LAK34, S-LAL18, J-LAK18, H-LaK52, FD60-W, N-SF6, S-TIH, J-SF6HS, H-ZF7LAGT, FD225, S-NPH, 1 W, J-SFH1, H-ZF71, E-FDS1-W, N-SF66, S-NPH, H-ZF62, E-FDS2, FDS16-W, FDS18-W, S-NPH, H-ZF88, FDS20-W, FDS24, FDS90-SG, N-SF57, S-TIH53 W, J-SF03, H-ZF52GT, NBFD10, N-LASF40, S-LAH60V, J-LASF010, H-ZLaF53B, NBFD13, N-LASF43, S-LAH53V, J-LASF03, H-ZLaF52A, NBFD15-W, J-LASFH6, H-ZLaF56B, NBFD30, TAF1, N-LAF34, S-LAH66, J-LASF016, H-LaF50B, TAF3D, N-LASF44, S-LAH65VS, J-LASF015, H-ZLaF50E, TAFD5G, N-LASF41, S-LAH55VS, J-LASF05, H-ZLaF55D, TAFD25, N-LASF46B, S-LAH95, J-LASFH13HS, H-ZLaF75B, TAFD30, N-LASF31A, S-LAH58, J-LASF08, H-ZLaF68N, TAFD32, TAFD33, TAFD35, J-LASFH9, H-ZLaF4LA, TAFD37A, H-ZLaF78B, TAFD40, J-LASFH17HS, H-ZLaF90, TAFD45, J-LASFH21, H-ZLaF89L, TAFD55, S-LAH79, J-LASFH16, and TAFD65.

In some embodiments, the set of one or more prisms is made of a second material that is distinct from the first material. In some embodiments, the second material is selected from the group consisting of: FCD1, N-PK52A, S-FPL51, J-FK01, H-FK61, FCD10A, H-FK71, FCD100, S-FPL53, FCD515, S-FPM2, J-PSKH1, H-ZPK5, FCD600, FCD705, PCD4, N-PSK53A, S-PHM52, J-PSK02, H-ZPK1A, PCD40, PCD51, S-FPM2, J-PSKH4, H-ZPK3, LAC8, N-LAK8, S-LAL, J-LAK8, H-LaK7A, LAC14, N-LAK14, S-LAL14, J-LAK14, H-LaK51A, TAC8, N-LAK34, S-LAL18, J-LAK18, H-LaK52, FD60-W, N-SF6, S-TIH, J-SF6HS, H-ZF7LAGT, FD225, S-NPH, 1 W, J-SFH1, H-ZF71, E-FDS1-W, N-SF66, S-NPH, H-ZF62, E-FDS2, FDS16-W, FDS18-W, S-NPH, H-ZF88, FDS20-W, FDS24, FDS90-SG, N-SF57, S-TIH53 W, J-SF03, H-ZF52GT, NBFD10, N-LASF40, S-LAH60V, J-LASF010, H-ZLaF53B, NBFD13, N-LASF43, S-LAH53V, J-LASF03, H-ZLaF52A, NBFD15-W, J-LASFH6, H-ZLaF56B, NBFD30, TAF1, N-LAF34, S-LAH66, J-LASF016, H-LaF50B, TAF3D, N-LASF44, S-LAH65VS, J-LASF015, H-ZLaF50E, TAFD5G, N-LASF41, S-LAH55VS, J-LASF05, H-ZLaF55D, TAFD25, N-LASF46B, S-LAH95, J-LASFH13HS, H-ZLaF75B, TAFD30, N-LASF31A, S-LAH58, J-LASF08, H-ZLaF68N, TAFD32, TAFD33, TAFD35, J-LASFH9, H-ZLaF4LA, TAFD37A, H-ZLaF78B, TAFD40, J-LASFH17HS, H-ZLaF90, TAFD45, J-LASFH21, H-ZLaF89L, TAFD55, S-LAH79, J-LASFH16, and TAFD65

In some embodiments, the second prism is made of a third material that is distinct from the first material and the second material. In some embodiments, the third material is selected from the group consisting of: FCD1, N-PK52A, S-FPL51, J-FK01, H-FK61, FCD10A, H-FK71, FCD100, S-FPL53, FCD515, S-FPM2, J-PSKH1, H-ZPK5, FCD600, FCD705, PCD4, N-PSK53A, S-PHM52, J-PSK02, H-ZPK1A, PCD40, PCD51, S-FPM2, J-PSKH4, H-ZPK3, LAC8, N-LAK8, S-LAL, J-LAK8, H-LaK7A, LAC14, N-LAK14, S-LAL14, J-LAK14, H-LaK51A, TAC8, N-LAK34, S-LAL18, J-LAK18, H-LaK52, FD60-W, N-SF6, S-TIH, J-SF6HS, H-ZF7LAGT, FD225, S-NPH, 1 W, J-SFH1, H-ZF71, E-FDS1-W, N-SF66, S-NPH, H-ZF62, E-FDS2, FDS16-W, FDS18-W, S-NPH, H-ZF88, FDS20-W, FDS24, FDS90-SG, N-SF57, S-TIH53 W, J-SF03, H-ZF52GT, NBFD10, N-LASF40, S-LAH60V, J-LASF010, H-ZLaF53B, NBFD13, N-LASF43, S-LAH53V, J-LASF03, H-ZLaF52A, NBFD15-W, J-LASFH6, H-ZLaF56B, NBFD30, TAF1, N-LAF34, S-LAH66, J-LASF016, H-LaF50B, TAF3D, N-LASF44, S-LAH65VS, J-LASF015, H-ZLaF50E, TAFD5G, N-LASF41, S-LAH55VS, J-LASF05, H-ZLaF55D, TAFD25, N-LASF46B, S-LAH95, J-LASFH13HS, H-ZLaF75B, TAFD30, N-LASF31A, S-LAH58, J-LASF08, H-ZLaF68N, TAFD32, TAFD33, TAFD35, J-LASFH9, H-ZLaF4LA, TAFD37A, H-ZLaF78B, TAFD40, J-LASFH17HS, H-ZLaF90, TAFD45, J-LASFH21, H-ZLaF89L, TAFD55, S-LAH79, J-LASFH16, and TAFD65. In some embodiments, the second prism is made of the first material.

In some embodiments, the third prism is made of the first material. In some embodiments, the third prism is made of a fourth material that is distinct from the first material, the second material, and the third material.

In some embodiments, the first prism and the third prism have identical shapes.

In some embodiments, the set of one or more prisms has a reflectively symmetric shape (e.g., the front view of the set of one or more prisms shown in FIG. 16A has a shape that is reflectively symmetric with respect to an axis that is perpendicular to the optical axis).

In some embodiments, the second prism has a reflectively symmetric shape (e.g., the front view of the second prism shown in FIG. 16A has a shape that is reflectively symmetric with respect to an axis that is perpendicular to the optical axis). For example, the second prism shown in FIG. 16A has a shape of an isosceles triangle.

In some embodiments, the prism assembly defines an optical axis (e.g., along a length of the prism assembly); and the first prism has at least two optical surfaces that include a first optical surface and a second optical surface, the first optical surface being non-perpendicular to the optical axis. For example, first surface 1812 of prism 1810 shown in FIG. 16B is an optical surface and is not perpendicular to the optical axis (along a horizontal axis of FIG. 16B).

In some embodiments, the second optical surface of the first prism is non-perpendicular to the optical axis. For example, second surface 1814 of prism 1810 shown in FIG. 16B is an optical surface and is not perpendicular to the optical axis.

In some embodiments, the third prism has at least two optical surfaces that include a first optical surface and a second optical surface, the first optical surface being non-perpendicular to the optical axis. For example, first surface 1842 of third prism 1840 is an optical surface and is not perpendicular to the optical axis.

In some embodiments, the second optical surface of the third prism is non-perpendicular to the optical axis. For example, second surface 1844 of third prism 1840 is an optical surface and is not perpendicular to the optical axis.

In some embodiments, the set of one or more prisms includes a single prism (e.g., prism 1820 shown in FIG. 16B).

In some embodiments, surfaces 1822, 1824, 1826, and 1828 of set 1820 of one or more prisms and surface 1832 and 1834 of prism 1830 are optical surfaces (e.g., each surface has a surface irregularity of λ/2 or less, such as λ/4, and a surface quality of 60-40 scratch-dig or better, such as 40-20 scratch-dig or 20-10 scratch-dig).

In some embodiments, surfaces 1816 and 1818 of first prism 1810, surface 1829 of set 1820 of one or more prisms, surface 1836 of second prism 1830, surfaces 1846 and 1848 of third prism 1840 are non-optical surfaces. In some embodiments, one or more of surfaces 1816, 1818, 1829, 1836, 1846, and 1848 are coated (e.g., with an optically opaque material) to prevent transmission of light.

In some embodiments, prism assembly 1800 has a length that is less than 50 mm (e.g., 45 mm, 40 mm, 35 mm, 30 mm, etc.). In some embodiments, prism assembly 1800 has a height (e.g., a distance between the top and bottom surfaces) that is less than 10 mm (e.g., 9.5 mm, 9.0 mm, 8.5 mm, 8 mm, etc.). In some embodiments, prism assembly 1800 has a width (e.g., a distance between the front and back surfaces) that is less than 8 mm (e.g., 7.5 mm, 7.0 mm, 6.5 mm, 6.0 mm, etc.).

In some embodiments, surfaces 1812 and 1818 form an angle that is between 90° and 180° (e.g., between 100° and 170°, between 110° and 160°, etc., such as 120°, 130°, 140°, or 150°). In some embodiments, surfaces 1816 and 1818 are substantially perpendicular to each other. In some embodiments, surfaces 1812 and 1814 form an angle that is between 70° and 130° (e.g., between 80° and 120°, between 90° and 110°, between 95° and 105°, etc.). In some embodiments, surfaces 1814 and 1816 form an angle that is between 30° and 80° (e.g., between 40° and 70°, between 40° and 50°, between 50° and 60°, between 60° and 70°, etc.). In some embodiments, surfaces 1832 and 1836 form an angle that is between 10° and 60° (e.g., between 20° and 50°, between 20° and 30°, between 30° and 40°, between 40° and 50°, etc.).

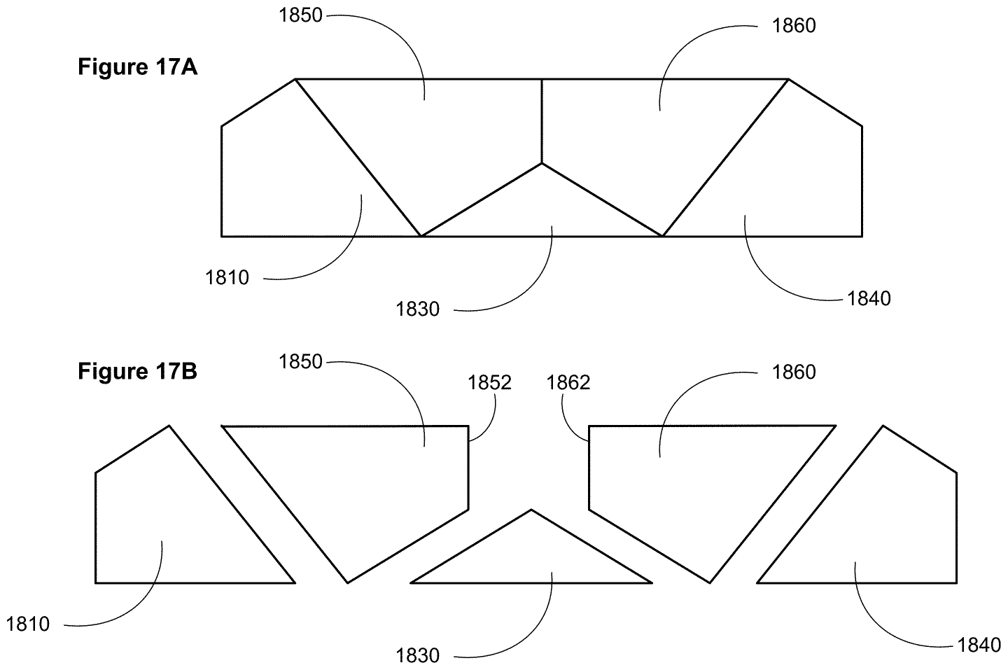

FIGS. 17A and 17B illustrate a prism assembly and its components in accordance with some embodiments. The prism assembly shown in FIGS. 17A and 17B are similar to prism assembly 1800 shown in FIGS. 16A and 16B except that the set of one or more prisms shown in FIGS. 17A and 17B include two prisms 1850 and 1860.

Thus, in some embodiments, the set of one or more prisms consists of two prisms (as shown in FIGS. 17A and 17B).

In some embodiments, prism 1850 has surface 1852 that is coupled with surface 1862 of prism 1860. In some embodiments, surfaces 1852 and 1862 are non-optical surfaces (e.g., a surface that has a surface irregularity greater than λ/2 and/or a surface quality worse than 60-40 scratch-dig). In some embodiments, one or more of surfaces 1852 and 1862 are coated (e.g., with an optically opaque material) to prevent transmission of light.

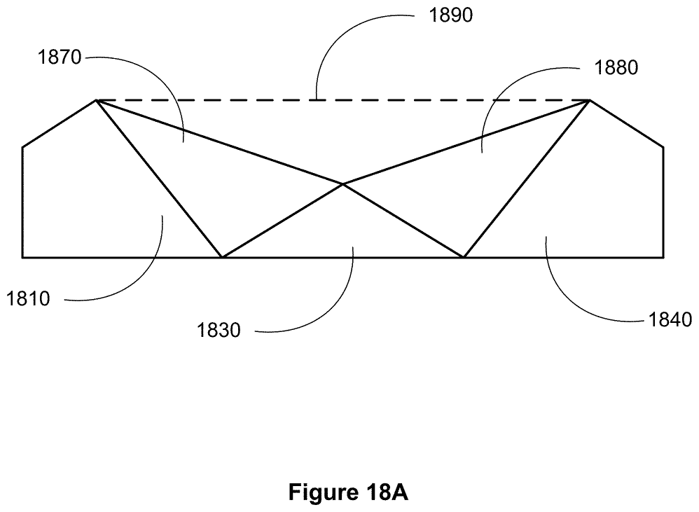

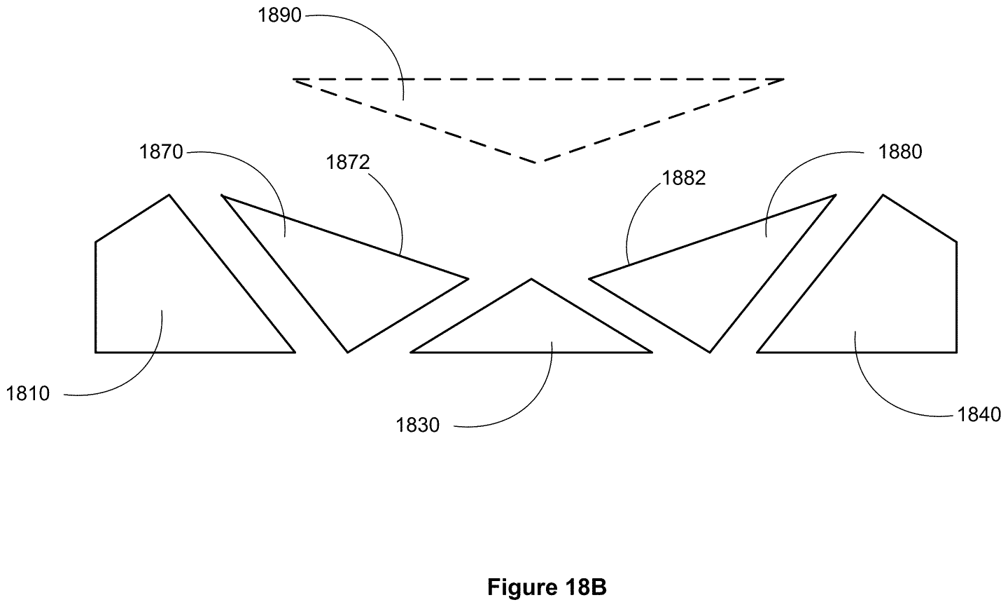

FIGS. 18A and 18B illustrate a prism assembly and its components in accordance with some embodiments. The prism assembly shown in FIGS. 18A and 18B are similar to prism assembly 1800 shown in FIGS. 16A and 16B except that the set of one or more prisms shown in FIGS. 18A and 18B include at least two prisms 1870 and 1880. In some embodiments, the set of one or more prisms also includes prism 1890.

Thus, in some embodiments, the set of one or more prisms consists of three prisms (e.g., prisms 1870, 1880, and 1890). In some embodiments, surface 1872 of prism 1870 and surface 1882 of prism 1880 are non-optical surfaces. In some embodiments, one or more of surface 1872 and 1882 are coated (e.g., with an optically opaque material) to prevent transmission of light.

In some embodiments, the set of one or more prisms includes four or more prisms.

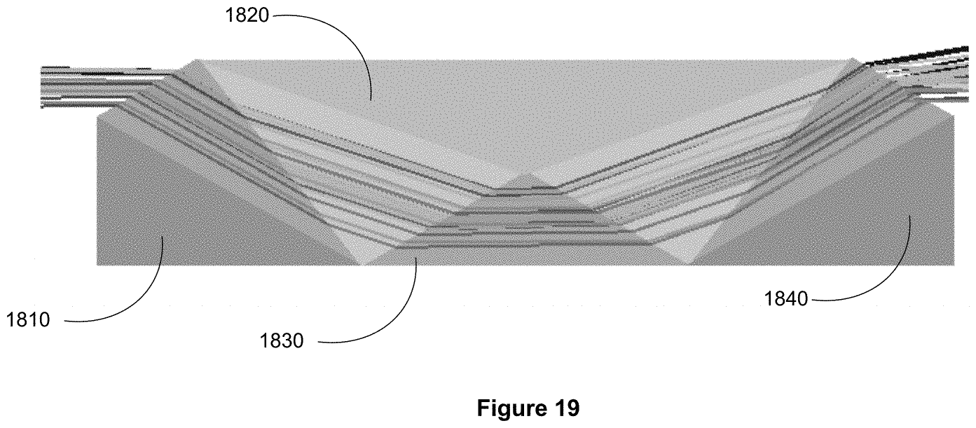

FIG. 19 illustrate rays passing through a prism assembly shown in FIGS. 16A-16B.

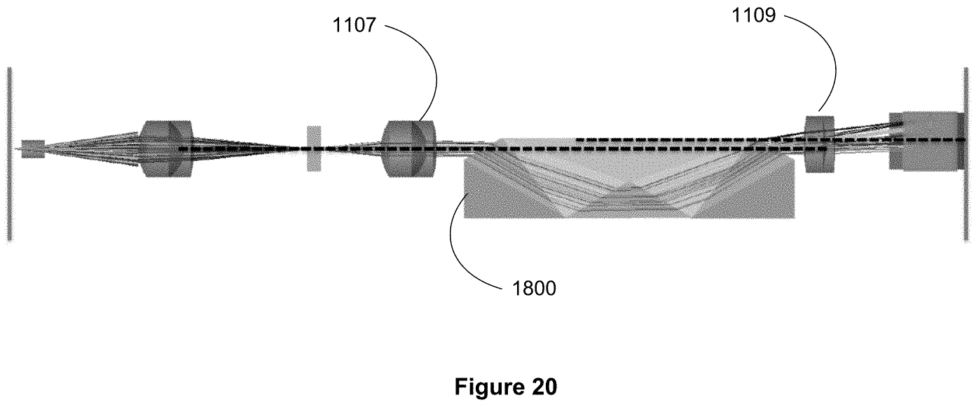

FIG. 20 illustrate rays in a spectrometer with the prism assembly shown in FIGS. 16A-16B in accordance with some embodiments. The spectrometer shown in FIG. 20 is similar to the spectrometer shown in FIG. 13 except that prism assembly 1800 is used in place of prism assembly 1310.

Prism assembly 1800 allows the spectrometer shown in FIG. 20 to have an arrangement in which first set 1107 of one or more lenses has an optical axis that is parallel to an optical axis of second set 1109 of one or more lenses. This, in turn, allows a compact spectrometer configuration (e.g., the width of the spectrometer is reduced compared to other spectrometers shown in FIG. 12).

In accordance with some embodiments, an apparatus (e.g., a spectrometer shown in FIG. 20) for analyzing light includes an input aperture for receiving light; a first set of one or more lenses configured to relay light from the input aperture; and any prism assembly described herein. The prism assembly is configured to disperse light from the first set of one or more lenses. The apparatus also includes a second set of one or more lenses configured to focus the dispersed light from the prism assembly; and an array detector configured for converting the light from the second set of one or more lenses to electrical signals.

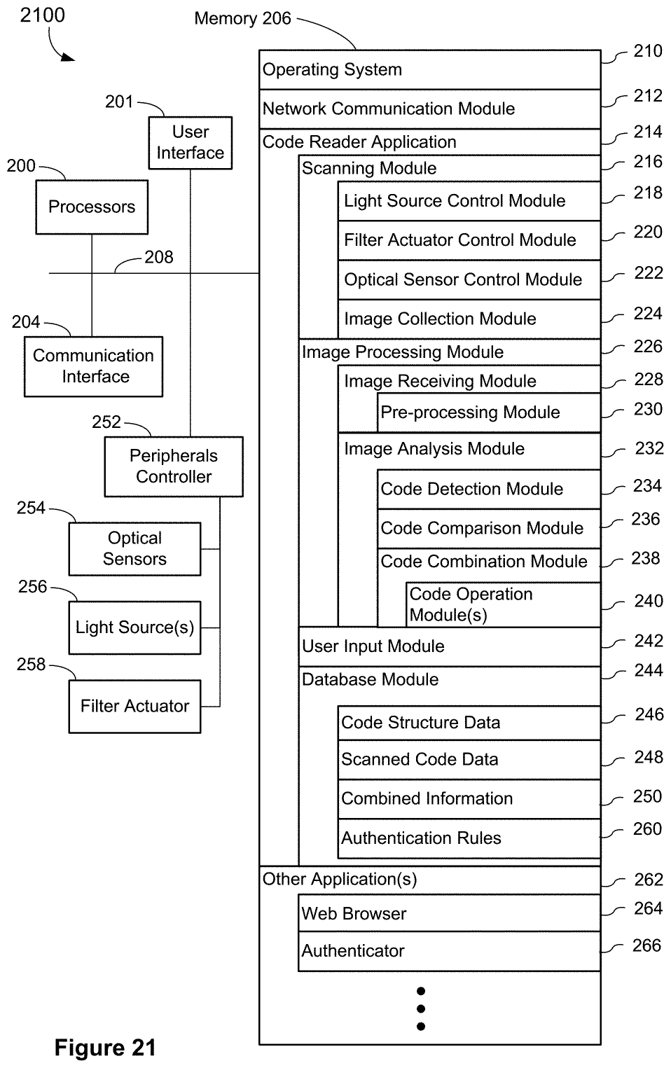

FIG. 21 is a block diagram illustrating components of electronic device 2100 in accordance with some embodiments. Electronic device 2100 typically includes one or more processing units 200 (central processing units, application processing units, application-specific integrated circuit, etc., which are also called herein processors), one or more network or other communications interfaces 204, memory 206, and one or more communication buses 208 for interconnecting these components. In some embodiments, communication buses 208 include circuitry (sometimes called a chipset) that interconnects and controls communications between system components. In some embodiments, electronic device 2100 includes a user interface 201 (e.g., a user interface having a display device, which can be used for displaying acquired images, one or more buttons, and/or other input devices). In some embodiments, electronic device 2100 also includes peripherals controller 252, which is configured to control operations of other electrical components of electronic device 2100, such as optical sensors 254 (e.g., the image sensor device as described with respect to FIG. 10), light source(s) 256 (e.g., infrared light source 1103), and optionally filter actuator 258 (e.g., initiating one or more light sources to emit light, receiving information, such as images, from optical sensors, and optionally actuating a filter, such as a filter wheel, so that light of a different wavelength range is provided to a machine readable code).

In some embodiments, communications interfaces 204 include wired communications interfaces and/or wireless communications interfaces (e.g., Wi-Fi, Bluetooth, etc.).

Memory 206 of electronic device 2100 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processors 200. Memory 206, or alternately the non-volatile memory device(s) within memory 206, comprises a computer readable storage medium (which includes a non-transitory computer readable storage medium and/or a transitory computer readable storage medium). In some embodiments, memory 206 includes a removable storage device (e.g., Secure Digital memory card, Universal Serial Bus memory device, etc.). In some embodiments, memory 206 or the computer readable storage medium of memory 206 stores the following programs, modules and data structures, or a subset thereof:
operating system 210 that includes procedures for handling various basic system services and for performing hardware dependent tasks;
network communication module (or instructions) 212 that is used for connecting electronic device 2100 to other computers (e.g., clients and/or servers) via one or more communications interfaces 204 and one or more communications networks, such as the Internet, other wide area networks, local area networks, metropolitan area networks, and so on;
code application 214 for reading and processing machine readable code; and
other applications 262, such as a web browser 264, or an authenticator application 266.

In some embodiments, code application 214 includes the following programs, modules and data structures, or a subset or superset thereof:
scanning module 216 configured for operating optoelectronic and optomechanical components in electronic device 2100 (e.g., optical sensors 254, light sources 256, and filter actuator 258);
image processing module 226 configured for analyzing received images;
user input module 242 configured for handling user inputs on electronic device 2100 (e.g., pressing of buttons of electronic device 2100, etc.); and
database module 244 configured to assist storage of data on electronic device 2100 and retrieval of data from electronic device 2100.

In some embodiments, scanning module 216 includes the following programs and modules, or a subset or superset thereof:
light source control module 218 configured for activating a particular light source for providing illumination light of a particular wavelength range (e.g., light source control module 218 activates at a first time a first light source for providing light of a first wavelength range without providing light a second wavelength range different from the first wavelength range and activates at a second time a second light source for providing light of the second wavelength range without providing light of the first wavelength range);
optical sensor control module 222 configured for operating optical sensors 254 to receive light and convert the received light into electrical signals;
filter actuator control module 220 configured for placing one or more particular filters in front of light sources 256 or optical sensors 254 so that light of a particular wavelength range is provided to illuminate a machine readable code or light of a particular wavelength range is received by optical sensors 254; and
image collection module 224 configured for converting electrical signals from optical sensors 254 into one or more images and collecting the images of machine readable code for a plurality of wavelength ranges.

In some embodiments, image processing module 226 includes the following programs and modules, or a subset or superset thereof:
image receiving module 228 configured for receiving image data (e.g., from scanning module 216, network communication module 212, or database module 244); and
image analysis module 232 configured for analyzing the image data.

In some embodiments, image processing module 226 includes the following programs and modules, or a subset or superset thereof:
image receiving module 228 configured for receiving image data (e.g., receiving information of code scanned by electronic device 2100 from scanning module 216, receiving information of code received by network communication module 212, or retrieving scanned code data 248 from database module 244); and
image analysis module 232 configured for analyzing the image data.

In some embodiments, image receiving module 228 includes pre-processing module 230 for pre-processing the image data (e.g., noise reduction, straightening, scaling, alignment, contrast adjustment, brightness adjustment, sharpening, background removal, etc.).

In some embodiments, image analysis module 232 includes the following programs and modules, or a subset or superset thereof:
code detection module 234 configured for determining whether a particular image includes machine readable code (e.g., based on information defined in code structure data 246 and/or detection of one or more markers in the particular image);
code comparison module 236 configured for comparing code information in two or more images (e.g., for determining whether the code information in two or more images is identical in its entirety or in part, and which portions, if any, of the code information is identical in the two or more images and/or which portions, if any, of the code information is different in the two or more images); and
code combination module 238 configured for combining code information in two or more images (e.g., stitching or concatenating code information in two or more images).

In some embodiments, code combination module 238 includes one or more code operation modules 240 configured for operations on the code information, such as arithmetic operations (e.g., sum, multiplication, subtraction, etc.) and/or logic operations (e.g., AND, OR, XOR, NAND, NOR, NOT, etc.).

In some embodiments, database module 244 includes the following information and data, or a subset or superset thereof:
code structure data 246 including information defining a structure of code (e.g., whether the code is a linear code or a matrix (e.g., two-dimensional) code, how many bars or blocks may be included in the code, positions and/or shapes of markers, etc.);
scanned code data 248 including one or more images of machine readable code;
combined information 250 including information from a plurality of images of machine readable code; and
authentication rules 260 including one or more rules for authenticating machine readable code (e.g., checksum calculation rules or reference checksum values, information identifying one or more images that should not contain code information, information identifying one or more images that should contain code information, information identifying one or more images that should contain duplicate images, information identifying one or more images that should contain complementary images, information identifying one or more regions of a respective image that should contain code information, etc.).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above.

Notwithstanding the discrete blocks in FIG. 21, these figures are intended to be a functional description of some embodiments, although, in some embodiments, the discrete blocks in FIG. 21 can be a structural description of functional elements in the embodiments. One of ordinary skill in the art will recognize that an actual implementation might have the functional elements grouped or split among various components. In practice, and as recognized by those of ordinary skill in the art, items shown separately could be combined and some items could be separated.

Although FIG. 21 shows that electronic device 2100 includes optical sensors 254, light sources 256, filter actuator 258, and code application 214 with scanning module 216, in some embodiments, electronic device 2100 does not include optical sensors 254, light sources 256, filter actuator 258, or scanning module 216. For example, electronic device 2100 may receive images collected by another device and process the received images.

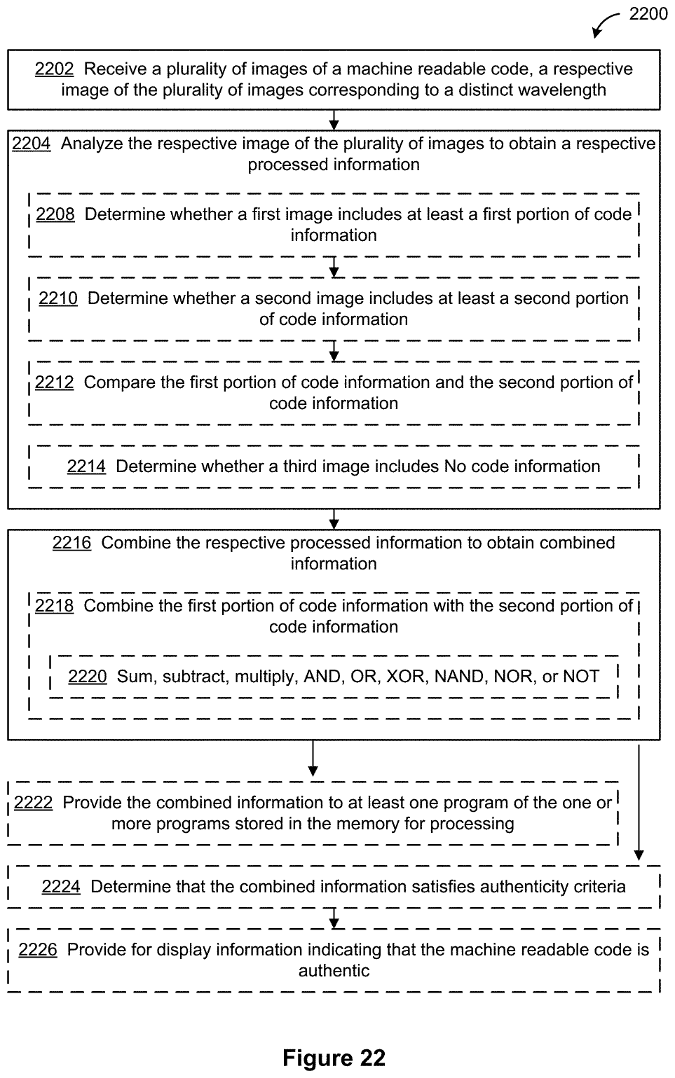

FIG. 22 is a flow chart representing method 2200 of processing images of a machine readable barcode in accordance with some embodiments.

Method 2200 is performed at an electronic device with one or more processors and memory (e.g., electronic device 2100). In some embodiments, the memory stores one or more programs (e.g., code application 214 and other applications 262, such as web browser 264 and/or authenticator 266).

Method 2200 includes (2202) receiving a plurality of images of a machine readable code (e.g., a linear or matrix cod printed on a packaging of a product). A respective image of the plurality of images corresponds to a distinct wavelength (e.g., multiple images of the machine readable code are taken for different wavelength ranges). For example, the plurality of images may include two or more of: an image of the machine readable code collected for 901 to 900 nm wavelength range, an image of the machine readable code collected for 1,000 to 1,100 nm wavelength range, an image of the machine readable code collected for 1,101 to 1,200 nm wavelength range, an image of the machine readable code collected for 1,201 to 1,300 nm wavelength range, an image of the machine readable code collected for 1,301 to 1,400 nm wavelength range, an image of the machine readable code collected for 1,401 to 1,500 nm wavelength range, and an image of the machine readable code collected for 1,501 to 1,600 nm wavelength range.

In some embodiments, method 2200 includes receiving the plurality of images from an image sensor device integrated with, or in communication with, the electronic device. In some embodiments, method 2200 includes receiving the plurality of images via network (e.g., using communication interface 204 and network communication module 212). In some embodiments, method 2200 includes retrieving the plurality of images from a database (e.g., using database module 244).

In some embodiments, the machine readable code is at least one of: a linear barcode or a matrix barcode. In some cases, the machine readable code is a linear barcode, such as a universal product code. In some other cases, the machine readable code is a matrix (two-dimensional code), such as a QR code prepared pursuant to ISO/IEC 18004.

Method 2200 includes (2204) analyzing the respective image of the plurality of images to obtain a respective processed information. For example, electronic device 2100 determines that the respective image contains code information (e.g., the respective image includes an image pattern of machine readable code), and extracts the code information. In some embodiments, the respective image of the machine readable code is decoded to obtain the respective processed information.

In some embodiments, the plurality of images includes a first image of the machine readable code corresponding to a first wavelength and a second image of the machine readable code corresponding to a second wavelength distinct from the first wavelength. For example, the first image includes an image of the machine readable code collected for 901 to 900 nm wavelength range, and the second image includes an image of the machine readable code collected for 1,101 to 1,200 nm wavelength range.

In some embodiments, method 2200 includes (2208) determining whether the first image includes at least a first portion of code information. For example, electronic device 2100 determines whether the first image includes a code based on code structure data 246 (e.g., electronic device 2100 determines whether the first image includes markers at locations indicated in code structure data 246).

In some embodiments, method 2200 includes (2210) determining whether the second image includes at least a second portion of code information. For example, electronic device 2100 determines whether the second image includes a code based on code structure data 246 (e.g., electronic device 2100 determines whether the second image includes markers at locations indicated in code structure data 246).

In some embodiments, method 2200 includes (2212) comparing the first portion of code information and the second portion of code information. For example, electronic device 2100 compares a shape (or a pattern) of the code in the first image and a shape (or a pattern) of the code in the second image (e.g., electronic device 2100 determines whether the shape (or the pattern) of the code in the first image and the shape (or the pattern) of the code in the second image at least partially overlap). In some embodiments, electronic device 2100 identifies one or more portions of the first image and one or more portions of the second image that overlap each other.

In some embodiments, the plurality of images includes a third image of the machine readable code corresponding to a third wavelength distinct from the first wavelength and the second wavelength. For example, the third image includes an image of the machine readable code collected for 1,301 to 1,400 nm wavelength range. Method 2200 also includes (2214) determining whether the third image includes no code information. For example, electronic device 2100 determines whether the third image includes a code based on code structure data 246 (e.g., electronic device 2100 determines whether the third image includes markers at locations indicated in code structure data 246). In some cases, the absence of code information in an image for a particular wavelength is used to determine whether the plurality of images is authentic or not (e.g., authentication rules 260 may require that the plurality of images of an authentic machine readable code includes no code information in an image corresponding to a particular wavelength and/or authentication rules 260 may require that the plurality of images of an authentic machine readable code includes code information in an image corresponding to another wavelength).

Method 2200 includes (2216) combining the respective processed information to obtain combined information. In some embodiments, combining the respective processed information includes concatenating code information from the first image with the code information from the second image (e.g., for the first image including code information corresponding to a string “ABCDEFGH” and the second image includes code information corresponding to a string “12345678,” electronic device 2100 combines the string “ABCDEFGH” and “12345678” to obtain a combined string “ABCDEFGH12345678.”).

In some embodiments, method 2200 includes (2218) combining the first portion of code information with the second portion of code information. In cases where the first image includes a first portion, less than all, of a machine readable code and the second image includes a second portion, less than all, of the machine readable code, in some embodiments, electronic device 2100 combines the first portion of the machine readable code in the first image and the second portion of the machine readable code in the second image to obtain a complete image of the machine readable code. In some embodiments, the first image includes a complete machine readable code (e.g., a full QR code) the second image includes a complete machine readable code (e.g., a full QR code), and electronic device 2100 combines the code information decoded from the first image with the code information decoded from the second image (e.g., by concatenating the code information decoded from the first image and the code information decoded from the second image and/or by performing one or more operations on the code information decoded from the first image and the code information decoded from the second image).

In some embodiments, combining the first portion of code information with the second portion of code information includes (2220) at least one of: summing at least a portion of the first portion of code information and at least a portion of the second portion of code information, subtracting at least a portion of the first portion of code information from at least a portion of the second portion of code information, subtracting at least a portion of the second portion of code information from at least a portion of the first portion of code information, performing a multiplication of at least a portion of the first portion of code information and at least a portion of the second portion of code information, performing an AND operation over at least a portion of the first portion of code information and at least a portion of the second portion of code information, performing an OR operation over at least a portion of the first portion of code information and at least a portion of the second portion of code information, performing an exclusive OR operation over at least a portion of the first portion of code information and at least a portion of the second portion of code information, performing a NAND operation over at least a portion of the first portion of code information and at least a portion of the second portion of code information, performing a NOR operation over at least a portion of the first portion of code information and at least a portion of the second portion of code information, performing a NOT operation on at least a portion of the first portion of code information, or performing a NOT operation on at least a portion of the second portion of code information.

In some embodiments, method 2200 includes (2222) providing the combined information to at least one program of the one or more programs stored in the memory for processing. For example, the combined information may include a universal resource locator (URL), and electronic device 2100 provides the universal resource locator to web browser 264 so that electronic device 2100 may retrieve and display a web page that corresponds to the universal resource locator using web browser 264. In some embodiments, the web page may contain information identifying authenticity corresponding to the universal resource locator. In another example, the combined information may include authenticating information (e.g., credentials) and electronic device 2100 provides the authenticating information to authenticator application 266 so that electronic device 2100 may determine whether the machine readable code (or a product with the machine readable code) is authentic using authenticator 266.

In some other embodiments, electronic device 2100 may determine the authenticity of the code information without using a separate application, such as authenticator application 266. For example, in some embodiments, method 2220 includes (2224) determining whether the combined information satisfies authenticity criteria, and (2226) providing for display information indicating whether the machine readable code is authentic. For example, electronic device 2100 may provide for display information indicating that the machine readable code is authentic in response to a determination that the combined information satisfies the authenticity criteria (e.g., authentication rules 260), and provide for display information indicating that the machine readable code is not authentic in response to a determination that the combined information does not satisfy the authenticity criteria.

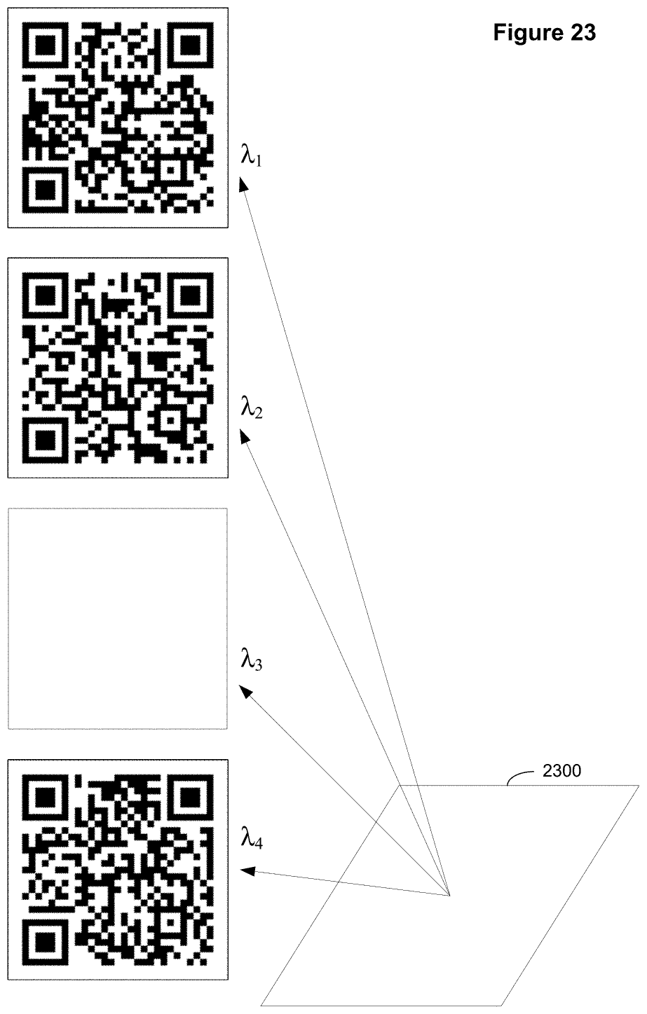

FIG. 23 is a schematic diagram illustrating a plurality of images of machine readable barcode 2300 taken at different wavelengths in accordance with some embodiments.

As shown in FIG. 23, machine readable barcode 2300 may not include any visible marks. However, in some embodiments, machine readable barcode 2300 also includes visible code (e.g., visible barcode) printed thereon. In some embodiments, machine readable barcode 2300 include visual non-code information (e.g., a logo or a brand associated with a manufacturer or a product).

Although machine readable barcode 2300 does not include any visible marks in FIG. 23, images of machine readable barcode 2300 taken using infrared light may contain barcode information. For example, in FIG. 23, an image of machine readable barcode 2300 taken at an infrared wavelength λ₁ contains barcode information. Similarly, each of an image of machine readable barcode 2300 taken at an infrared wavelength λ₂ and an image of machine readable barcode 2300 taken at an infrared wavelength λ₄ contains barcode information. An image of machine readable barcode 2300 taken at an infrared wavelength λ₃ does not contain barcode information. These images, taken at different infrared wavelengths, are used to obtain combined code information as described above with respect to FIG. 22.

In some embodiments, machine readable barcode 2300 is located (e.g., printed) on a substrate (e.g., paper, a plastic film, etc.). In some embodiments, machine readable barcode 2300 (or the substrate on which machine readable barcode 2300 is located) has a plurality of regions (e.g., 21×21, 25×25, 29×29, 33×33, or 57×57 regions). A first subset of the plurality of regions is covered with one or more pigments of a first type corresponding to a first wavelength, λ₁. A second subset, distinct from the first subset, of the plurality of regions is covered with one or more pigments of a second type corresponding to a second wavelength λ₂. One or more regions of the plurality of regions are covered with both the one or more pigments of the first type and the one or more pigments of the second type. One or more regions of the plurality of regions are covered with the one or more pigments of the first type without the one or more pigments of the second type.

In some embodiments, the one or more pigments of the first type and the one or more pigments of the second type do not have any visible color (e.g., the one or more pigments of the first type and the one or more pigments of the second type do not absorb visible light).

In some embodiments, one or more regions of the plurality of regions are covered with the one of more pigments of the second type without the one or more pigments of the first type.

In some embodiments, one or more regions of the plurality of regions are covered with neither the one or more pigments of the first type nor the one or more pigments of the second type.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at an electronic device with one or more processors and memory storing one or more programs:
receiving a plurality of images of a machine readable code, a respective image of the plurality of images corresponding to a distinct wavelength;
analyzing the respective image of the plurality of images to obtain a respective processed information;
combining the respective processed information to obtain combined information; and
providing the combined information to at least one program of the one or more programs stored in the memory for processing.

2. The method of claim 1, wherein:
the plurality of images includes a first image of the machine readable code corresponding to a first wavelength and a second image of the machine readable code corresponding to a second wavelength distinct from the first wavelength.

3. The method of claim 2, including:
determining whether the first image includes at least a first portion of code information.

4. The method of claim 3, including:
determining whether the second image includes at least a second portion of code information.

5. The method of claim 4, including:
comparing the first portion of code information and the second portion of code information.

6. The method of claim 4, including:
combining the first portion of code information with the second portion of code information.

7. The method of claim 6, wherein:
combining the first portion of code information with the second portion of code information includes at least one of: summing at least a portion of the first portion of code information and at least a portion of the second portion of code information, subtracting at least a portion of the first portion of code information from at least a portion of the second portion of code information, subtracting at least a portion of the second portion of code information from at least a portion of the first portion of code information, performing a multiplication of at least a portion of the first portion of code information and at least a portion of the second portion of code information, performing an AND operation over at least a portion of the first portion of code information and at least a portion of the second portion of code information, performing an OR operation over at least a portion of the first portion of code information and at least a portion of the second portion of code information, performing an exclusive OR operation over at least a portion of the first portion of code information and at least a portion of the second portion of code information, performing a NAND operation over at least a portion of the first portion of code information and at least a portion of the second portion of code information, performing a NOR operation over at least a portion of the first portion of code information and at least a portion of the second portion of code information, performing a NOT operation on at least a portion of the first portion of code information, or performing a NOT operation on at least a portion of the second portion of code information.

8. The method of claim 2, wherein:
the plurality of images includes a third image of the machine readable code corresponding to a third wavelength distinct from the first wavelength and the second wavelength; and
the method includes determining whether the third image includes no code information.

9. The method of claim 1, further comprising:
determining that the combined information satisfies authenticity criteria.

10. An electronic device, comprising:
one or more processors; and
memory storing one or more programs, the one or more programs including instructions, which, when executed by the one or more processors, cause the electronic device to:
receive a plurality of images of a machine readable code, a respective image of the plurality of images corresponding to a distinct wavelength;
analyze the respective image of the plurality of images to obtain a respective processed information;
combine the respective processed information to obtain combined information; and
provide the combined information to at least one program of the one or more programs stored in the memory for processing.

11. The electronic device of claim 10, including:
one or more optical sensor devices, a respective optical sensor device of the one or more optical sensor devices including:
a first semiconductor region doped with a dopant of a first type;
a second semiconductor region doped with a dopant of a second type, wherein:
the second semiconductor region is positioned above the first semiconductor region; and
the first type is distinct from the second type;
a gate insulation layer positioned above the second semiconductor region;
a gate positioned above the gate insulation layer;
a source electrically coupled with the second semiconductor region; and
a drain electrically coupled with the second semiconductor region, wherein:
the second semiconductor region has a top surface that is positioned toward the gate insulation layer;
the second semiconductor region has a bottom surface that is positioned opposite to the top surface of the second semiconductor region;
the second semiconductor region has an upper portion that includes the top surface of the second semiconductor region;
the second semiconductor region has a lower portion that includes the bottom surface of the second semiconductor region and is mutually exclusive with the upper portion;
the first semiconductor region is in contact with both the upper portion and the lower portion of the second semiconductor region; and
the first semiconductor region is in contact with the upper portion of the second semiconductor region at least at a location positioned under the gate.

12. The electronic device of claim 11, including:
a spectrometer including:
an input aperture for receiving light;
a first set of one or more lenses configured to relay light from the input aperture;
a prism assembly configured to disperse light from the first set of one or more lenses, the prism assembly including a plurality of prisms that includes a first prism, a second prism that is distinct from the first prism, and a third prism that is distinct from the first prism and the second prism, wherein the first prism is mechanically coupled with the second prism and the second prism is mechanically coupled with the third prism;
a second set of one or more lenses configured to focus the dispersed light from the prism assembly; and
an array detector configured for converting the light from the second set of one or more lenses to electrical signals.

13. The electronic device of claim 11, including:
a prism assembly including:
a first prism that is distinct from the set of one or more prisms and is mechanically coupled with the set of one or more prisms;
a second prism that is distinct from the set of one or more prisms and the first prism and is mechanically coupled with the set of one or more prisms; and
a third prism that is distinct from the set of one or more prisms, the first prism, and the second prism and is mechanically coupled with the set of one or more prisms.

14. The electronic device of claim 10, wherein:
the plurality of images includes a first image of the machine readable code corresponding to a first wavelength and a second image of the machine readable code corresponding to a second wavelength distinct from the first wavelength.

15. The electronic device of claim 14, wherein:
the one or more programs include instructions for determining whether the first image includes at least a first portion of code information.

16. The electronic device of claim 15, wherein:
the one or more programs include instructions for determining whether the second image includes at least a second portion of code information.

17. The electronic device of claim 16, wherein:
the one or more programs include instructions for comparing the first portion of code information and the second portion of code information.

18. The electronic device of claim 16, wherein:
the one or more programs include instructions for combining the first portion of code information with the second portion of code information.

19. The electronic device of claim 18, wherein:
combining the first portion of code information with the second portion of code information includes at least one of: summing at least a portion of the first portion of code information and at least a portion of the second portion of code information, subtracting at least a portion of the first portion of code information from at least a portion of the second portion of code information, subtracting at least a portion of the second portion of code information from at least a portion of the first portion of code information, performing a multiplication of at least a portion of the first portion of code information and at least a portion of the second portion of code information, performing an AND operation over at least a portion of the first portion of code information and at least a portion of the second portion of code information, performing an OR operation over at least a portion of the first portion of code information and at least a portion of the second portion of code information, performing an exclusive OR operation over at least a portion of the first portion of code information and at least a portion of the second portion of code information, performing a NAND operation over at least a portion of the first portion of code information and at least a portion of the second portion of code information, performing a NOR operation over at least a portion of the first portion of code information and at least a portion of the second portion of code information, performing a NOT operation on at least a portion of the first portion of code information, or performing a NOT operation on at least a portion of the second portion of code information.

20. A computer readable storage medium storing one or more programs for execution by one or more processors of an electronic device, the one or more programs including instructions for:
receiving a plurality of images of a machine readable code, a respective image of the plurality of images corresponding to a distinct wavelength;
analyzing the respective image of the plurality of images to obtain a respective processed information;
combining the respective processed information to obtain combined information; and
providing the combined information to at least one program of the one or more programs stored in memory of the electronic device for processing.
